(19) United States
(12) Patent Application Publication
(10) Pub. No.: US 2026/0353152 A1
(43) Pub. Date: Nov. 5, 2026

(54) REPORTING CAPABILITY FOR MOBILITY PREDICTION

(71) Applicant: QUALCOMM Incorporated, San Diego, CA (US)

(72) Inventors: Rajeev KUMAR, San Diego, CA (US); Aziz GHOLMIEH, Del Mar, CA (US); Punyaslok PURKAYASTHA, San Diego, CA (US); Hamed PEZESHKI, San Diego, CA (US)

(21) Appl. No.: 19/649,440

(22) Filed: Apr. 16, 2026

Related U.S. Application Data
(60) Provisional application No. 63/792,732, filed on Apr. 22, 2025.

(51) Int. Cl. H04W 24/10; H04W 8/24

(52) U.S. Cl. CPC H04W 24/10; H04W 8/24

(57) ABSTRACT

Various aspects of the present disclosure generally relate to wireless communication. In some aspects, a user equipment (UE) may transmit a capability message that includes at least a first parameter related to possible input for radio resource management (RRM) prediction, measurement event prediction, or a combination thereof, and a second parameter related to possible output for RRM prediction, measurement event prediction, or a combination thereof. The UE may receive a report configuration, based at least in part on the first parameter and the second parameter, and may transmit a report according to the report configuration. Numerous other aspects are described.

### CROSS-REFERENCE TO RELATED APPLICATION

This Patent Application claims priority to U.S. Provisional Patent Application No. 63/792,732, filed on Apr. 22, 2025, entitled “REPORTING CAPABILITY FOR MOBILITY PREDICTION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with reporting capability for mobility prediction.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In a wireless network, a user equipment (UE) may apply models for beam prediction. For example, the UE may use measurements from a first set of beams to predict measurements for a second set of beams. The UE may predict measurements across space (e.g., the first set of beams being wider than the second set of beams) or across time (e.g., predicting future measurements for the second set of beams using historic measurements of the first set of beams).

### SUMMARY

The systems, methods, and devices of this disclosure each have several innovative aspects, no single one of which is solely responsible for the desirable attributes disclosed herein.

Some aspects described herein relate to a method of wireless communication performed by a user equipment (UE). The method may include transmitting a capability message that includes at least a first parameter related to possible input for radio resource management (RRM) prediction, measurement event prediction, or a combination thereof, and a second parameter related to possible output for RRM prediction, measurement event prediction, or a combination thereof. The method may include receiving a report configuration based at least in part on the first parameter and the second parameter. The method may include transmitting a report according to the report configuration.

Some aspects described herein relate to a method of wireless communication performed by a network node. The method may include receiving a capability message, associated with a UE, that includes at least a first parameter related to possible input for RRM prediction, measurement event prediction, or a combination thereof, and a second parameter related to possible output for RRM prediction, measurement event prediction, or a combination thereof. The method may include transmitting a report configuration based at least in part on the first parameter and the second parameter. The method may include receiving a report according to the report configuration.

Some aspects described herein relate to a method of wireless communication performed by a UE. The method may include receiving a report configuration that includes at least a first parameter indicating measurement resources for RRM prediction, measurement event prediction, or a combination thereof, and a second parameter indicating prediction resources for the RRM prediction, the measurement event prediction, or the combination thereof. The method may include transmitting a prediction result for the prediction resources using the measurement resources and based on the report configuration.

Some aspects described herein relate to a method of wireless communication performed by a network node. The method may include transmitting a report configuration that includes at least a first parameter indicating measurement resources for RRM prediction, measurement event prediction, or a combination thereof, and a second parameter indicating prediction resources for the RRM prediction, the measurement event prediction, or the combination thereof. The method may include receiving a prediction result for the prediction resources using the measurement resources and based on the report configuration.

Some aspects described herein relate to a UE. The UE may include an antenna system that includes one or more antennas and a processing system that includes one or more processors and one or more memories that store code and are coupled with the one or more processors. The processing system may be configured to cause the UE to wirelessly transmit a capability message that includes at least a first parameter related to possible input for RRM prediction, measurement event prediction, or a combination thereof, and a second parameter related to possible output for RRM prediction, measurement event prediction, or a combination thereof. The processing system may be configured to cause the UE to wirelessly receive a report configuration based at least in part on the first parameter and the second parameter. The processing system may be configured to cause the UE to wirelessly transmit a report according to the report configuration.

Some aspects described herein relate to a network node. The network node may include an antenna system that includes one or more antennas and a processing system that includes one or more processors and one or more memories that store code and are coupled with the one or more processors. The processing system may be configured to cause the network node to wirelessly receive a capability message, associated with a UE, that includes at least a first parameter related to possible input for RRM prediction, measurement event prediction, or a combination thereof, and a second parameter related to possible output for RRM prediction, measurement event prediction, or a combination thereof. The processing system may be configured to cause the network node to wirelessly transmit a report configuration based at least in part on the first parameter and the second parameter. The processing system may be configured to cause the network node to wirelessly receive a report according to the report configuration.

Some aspects described herein relate to a UE. The UE may include an antenna system that includes one or more antennas and a processing system that includes one or more processors and one or more memories that store code and are coupled with the one or more processors. The processing system may be configured to cause the UE to wirelessly receive a report configuration that includes at least a first parameter indicating measurement resources for RRM prediction, measurement event prediction, or a combination thereof, and a second parameter indicating prediction resources for the RRM prediction, the measurement event prediction, or the combination thereof. The processing system may be configured to cause the UE to wirelessly transmit a prediction result for the prediction resources using the measurement resources and based on the report configuration.

Some aspects described herein relate to a network node. The network node may include an antenna system that includes one or more antennas and a processing system that includes one or more processors and one or more memories that store code and are coupled with the one or more processors. The processing system may be configured to cause the network node to wirelessly transmit a report configuration that includes at least a first parameter indicating measurement resources for RRM prediction, measurement event prediction, or a combination thereof, and a second parameter indicating prediction resources for the RRM prediction, the measurement event prediction, or the combination thereof. The processing system may be configured to cause the network node to wirelessly receive a prediction result for the prediction resources using the measurement resources and based on the report configuration.

Some aspects described herein relate to a non-transitory computer-readable medium that stores a set of instructions for wireless communication by a UE. The set of instructions, when executed by one or more processors of the UE, may cause the UE to transmit a capability message that includes at least a first parameter related to possible input for RRM prediction, measurement event prediction, or a combination thereof, and a second parameter related to possible output for RRM prediction, measurement event prediction, or a combination thereof. The set of instructions, when executed by one or more processors of the UE, may cause the UE to receive a report configuration based at least in part on the first parameter and the second parameter. The set of instructions, when executed by one or more processors of the UE, may cause the UE to transmit a report according to the report configuration.

Some aspects described herein relate to a non-transitory computer-readable medium that stores a set of instructions for wireless communication by a network node. The set of instructions, when executed by one or more processors of the network node, may cause the network node to receive a capability message, associated with a UE, that includes at least a first parameter related to possible input for RRM prediction, measurement event prediction, or a combination thereof, and a second parameter related to possible output for RRM prediction, measurement event prediction, or a combination thereof. The set of instructions, when executed by one or more processors of the network node, may cause the network node to transmit a report configuration based at least in part on the first parameter and the second parameter. The set of instructions, when executed by one or more processors of the network node, may cause the network node to receive a report according to the report configuration.

Some aspects described herein relate to a non-transitory computer-readable medium that stores a set of instructions for wireless communication by a UE. The set of instructions, when executed by one or more processors of the UE, may cause the UE to receive a report configuration that includes at least a first parameter indicating measurement resources for RRM prediction, measurement event prediction, or a combination thereof, and a second parameter indicating prediction resources for the RRM prediction, the measurement event prediction, or the combination thereof. The set of instructions, when executed by one or more processors of the UE, may cause the UE to transmit a prediction result for the prediction resources using the measurement resources and based on the report configuration.

Some aspects described herein relate to a non-transitory computer-readable medium that stores a set of instructions for wireless communication by a network node. The set of instructions, when executed by one or more processors of the network node, may cause the network node to transmit a report configuration that includes at least a first parameter indicating measurement resources for RRM prediction, measurement event prediction, or a combination thereof, and a second parameter indicating prediction resources for the RRM prediction, the measurement event prediction, or the combination thereof. The set of instructions, when executed by one or more processors of the network node, may cause the network node to receive a prediction result for the prediction resources using the measurement resources and based on the report configuration.

Some aspects described herein relate to an apparatus for wireless communication. The apparatus may include means for transmitting a capability message that includes at least a first parameter related to possible input for RRM prediction, measurement event prediction, or a combination thereof, and a second parameter related to possible output for RRM prediction, measurement event prediction, or a combination thereof. The apparatus may include means for receiving a report configuration based at least in part on the first parameter and the second parameter. The apparatus may include means for transmitting a report according to the report configuration.

Some aspects described herein relate to an apparatus for wireless communication. The apparatus may include means for receiving a capability message, associated with a UE, that includes at least a first parameter related to possible input for RRM prediction, measurement event prediction, or a combination thereof, and a second parameter related to possible output for RRM prediction, measurement event prediction, or a combination thereof. The apparatus may include means for transmitting a report configuration based at least in part on the first parameter and the second parameter. The apparatus may include means for receiving a report according to the report configuration.

Some aspects described herein relate to an apparatus for wireless communication. The apparatus may include means for receiving a report configuration that includes at least a first parameter indicating measurement resources for RRM prediction, measurement event prediction, or a combination thereof, and a second parameter indicating prediction resources for the RRM prediction, the measurement event prediction, or the combination thereof. The apparatus may include means for transmitting a prediction result for the prediction resources using the measurement resources and based on the report configuration.

Some aspects described herein relate to an apparatus for wireless communication. The apparatus may include means for transmitting a report configuration that includes at least a first parameter indicating measurement resources for RRM prediction, measurement event prediction, or a combination thereof, and a second parameter indicating prediction resources for the RRM prediction, the measurement event prediction, or the combination thereof. The apparatus may include means for receiving a prediction result for the prediction resources using the measurement resources and based on the report configuration.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example of artificial intelligence or machine learning based beam management.

FIG. 3 is a diagram illustrating an example associated with reporting capability for mobility prediction.

FIG. 4 is a diagram illustrating an example process performed, for example, by a user equipment (UE).

FIG. 5 is a diagram illustrating an example process performed, for example, by a network node.

FIG. 6 is a diagram illustrating an example process performed, for example, by a UE.

FIG. 7 is a diagram illustrating an example process performed, for example, by a network node.

FIGS. 8 and 9 are diagrams of example apparatuses for wireless communication.

### DETAILED DESCRIPTION

5G New Radio (NR), 6G, or other wireless communication systems may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, frequency spectrum expansion, overlapping spectrum use, sidelink and other device-to-device direct communication (for example, cellular vehicle-to-everything (CV2X) communication), small cell deployments, non-terrestrial network (NTN) deployments, device aggregation, advanced duplex communication (for example, full duplex or sub-band full-duplex (SBFD)), multiple-subscriber implementations, high-precision positioning, low-power signaling and radios, network automation, remote operation, enhanced fixed wireless access, predictive sensors, or artificial intelligence (AI) or machine learning (ML) (AI/ML) including network-native AI/ML, agentic AI, distributed AI/ML (for example, across user equipments (UEs), network nodes, edge computing devices, or cloud computing devices), or collaborative learning for AI/ML, among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, intelligent manufacturing and industrial automation (for example, via ambient IoT technology), intelligent transportation (for example, vehicle platooning and cooperative maneuvering), sensing networks (such as radio frequency (RF) sensing or integrated sensing and communication (ISAC)), gesture monitoring, human-brain interfacing, digital twin applications (for example, digital representations of wireless communication systems and the physical world), asset management, efficient energy usage (for example, network energy savings (NES) applications, or analog AI/ML for improved energy efficiency in data centers) or universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

In a wireless network, a user equipment (UE) may perform mobility prediction. Mobility prediction may include radio resource management (RRM) prediction (e.g., prediction for a serving cell, one or more neighboring cells, or a combination thereof), measurement event prediction, or a combination thereof. To enable mobility prediction, a network may configure the UE to measure reference signals representing a set of input cells or beams. The UE may therefore perform inference using measurements on the reference signals. The network also may configure prediction targets representing a set of output cells or beams. The UE may therefore transmit a report indicating predictions associated with the prediction targets.

However, the UE may have limitations related to mobility prediction (e.g., due to hardware constraints, software constraints, or a combination thereof). Therefore, the UE will generally reject a configuration from the network, associated with mobility prediction, if the configuration exceeds a capability of the UE.

Various aspects relate generally to a UE reporting a capability, associated with RRM prediction, measurement event prediction, or a combination thereof, to a network. Some aspects more specifically relate to the UE indicating (at least) a first parameter related to possible input and a second parameter related to possible output. In some aspects, the network may provide a report configuration based at least in part on the first parameter and the second parameter. Accordingly, the UE may perform inference, according to the report configuration, and provide a report indicating a result from the inference. The result may be a beam prediction, a cell prediction, a measurement event prediction, or a combination thereof.

Particular aspects of the subject matter described in this disclosure can be implemented to realize one or more of the following potential advantages. In some examples, the described techniques can be used to prevent waste of power, processing resources, and network resources that would occur if the network were to provide an unsupported configuration for mobility prediction to the UE. Additionally, the described techniques can be used to speed up (or otherwise enhance) secondary cell (SCell) configuration or handover, among other examples, using mobility prediction.

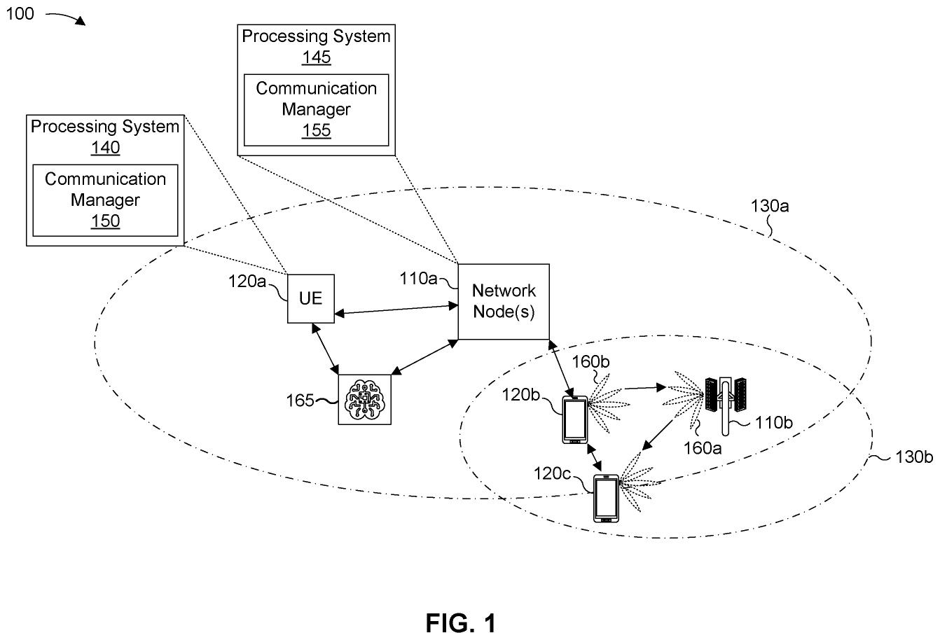

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a cyclic prefix OFDM (CP-OFDM) waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model, or one or more AI agents, among other examples. In some contexts and examples, “AI agent” may refer to an automated intelligent entity capable of, for example, interacting with its environment, acquiring contextual information, reasoning, self-learning, decision-making, or executing tasks (autonomously or in collaboration with other AI agents) to achieve a specific goal. An AI agent may utilize various machine learning techniques, artificial neural networks, or other forms of computational intelligence to adapt its behavior based on observed data or feedback. In some examples, an AI agent may operate independently or as part of a distributed system, collaborating with other agents or network components to optimize network performance, resource allocation, or user experience. The capabilities of an AI agent may include, but are not limited to, dynamic adaptation to changing network conditions, predictive analytics, anomaly detection, or autonomous orchestration of network functions, among other

examples.

The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, the UE 120 may include a processing system 140 with a communication manager 150. As described in more detail elsewhere herein, the communication manager 150 may transmit a capability message that includes at least a first parameter related to possible input for RRM prediction, measurement event prediction, or a combination thereof, and a second parameter related to possible output for RRM prediction, measurement event prediction, or a combination thereof; may receive a report configuration based at least in part on the first parameter and the second parameter; and may transmit a report according to the report configuration. Additionally, or alternatively, as described in more detail elsewhere herein, the communication manager 150 may receive a report configuration that includes at least a first parameter indicating measurement resources for RRM prediction, measurement event prediction, or a combination thereof, and a second parameter indicating prediction resources for the RRM prediction, the measurement event prediction, or the combination thereof; and may transmit a prediction result for the prediction resources using the measurement resources and based on the report configuration. Additionally, or alternatively, the communication manager 150 may perform one or more other operations described herein.

In some aspects, the network node 110 may include a processing system 145 with a communication manager 155. As described in more detail elsewhere herein, the communication manager 155 may receive a capability message, associated with a UE, that includes at least a first parameter related to possible input for RRM prediction, measurement event prediction, or a combination thereof, and a second parameter related to possible output for RRM prediction, measurement event prediction, or a combination thereof; may transmit a report configuration based at least in part on the first parameter and the second parameter; and may receive a report according to the report configuration. Additionally, or alternatively, as described in more detail elsewhere herein, the communication manager 155 may transmit a report configuration that includes at least a first parameter indicating measurement resources for RRM prediction, measurement event prediction, or a combination thereof, and a second parameter indicating prediction resources for the RRM prediction, the measurement event prediction, or the combination thereof; and may receive a prediction result for the prediction resources using the measurement resources and based on the report configuration. Additionally, or alternatively, the communication manager 155 may perform one or more other operations described herein.

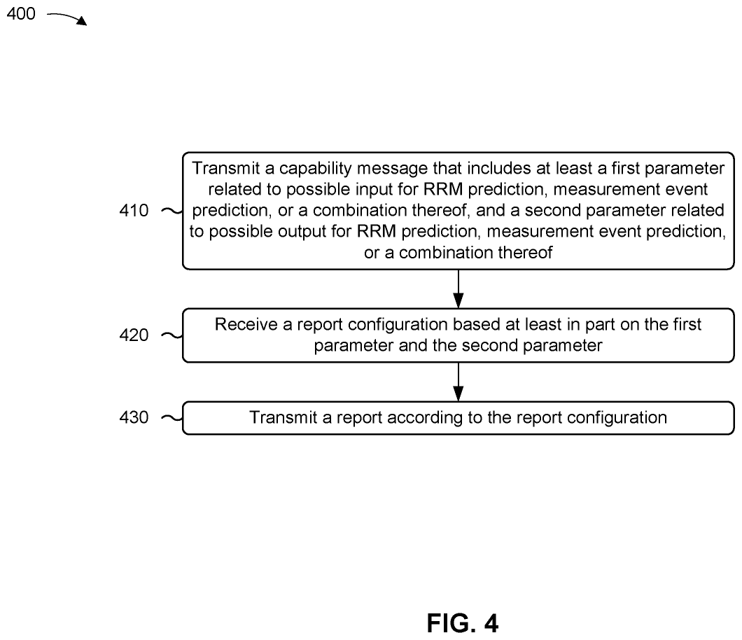

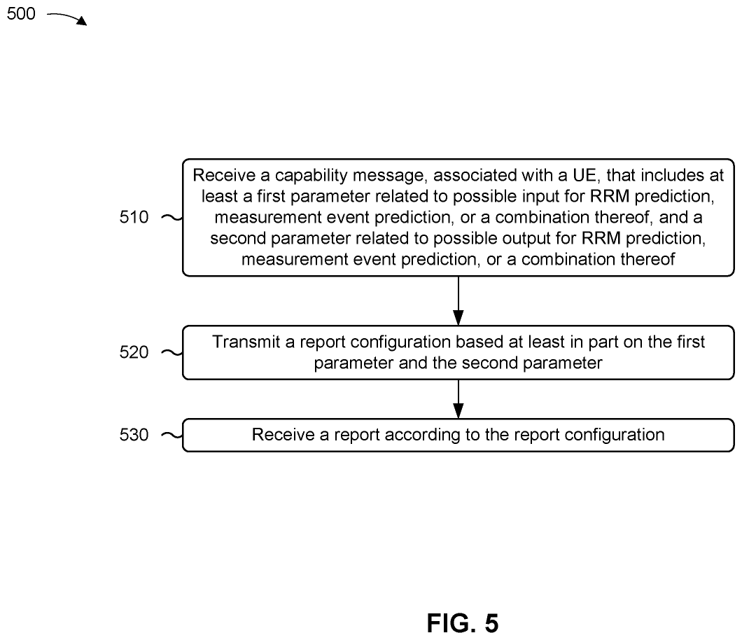

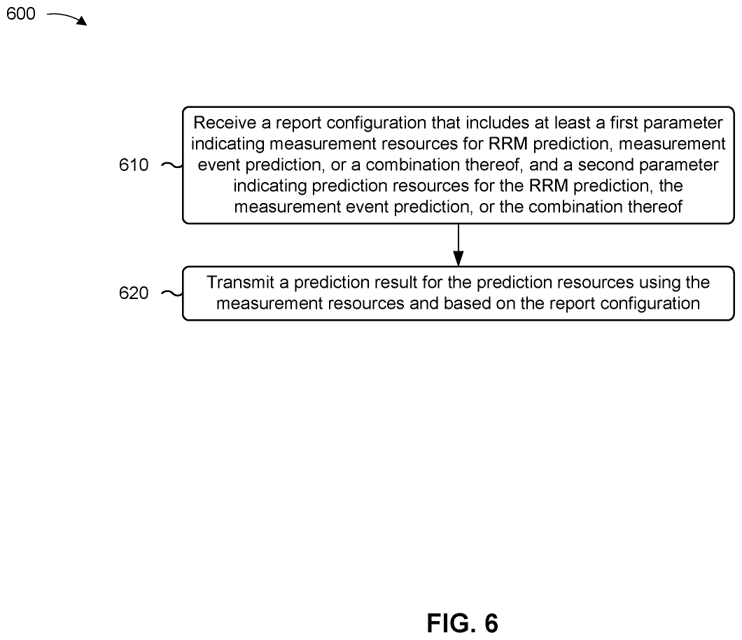

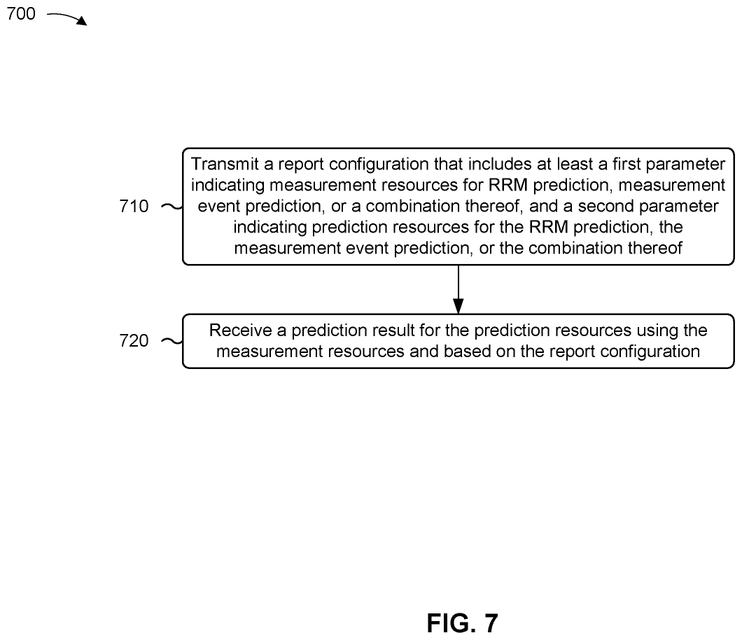

The network node 110, the processing system 145 of the network node 110, the UE 120, the processing system 140 of the UE 120, or any other component(s) of FIG. 1 may implement one or more techniques or perform one or more operations associated with reporting capability for mobility prediction, as described in more detail elsewhere herein. For example, the processing system 145 of the network node 110, or the processing system 140 of the UE 120 may perform or direct operations of, for example, process 400 of FIG. 4, process 500 of FIG. 5, process 600 of FIG. 6, process 700 of FIG. 7, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 400 of FIG. 4, process 500 of FIG. 5, process 600 of FIG. 6, process 700 of FIG. 7, or other processes as described herein. In some examples, executing instructions may include running the instructions, converting the instructions, compiling the instructions, or interpreting the instructions, among other examples.

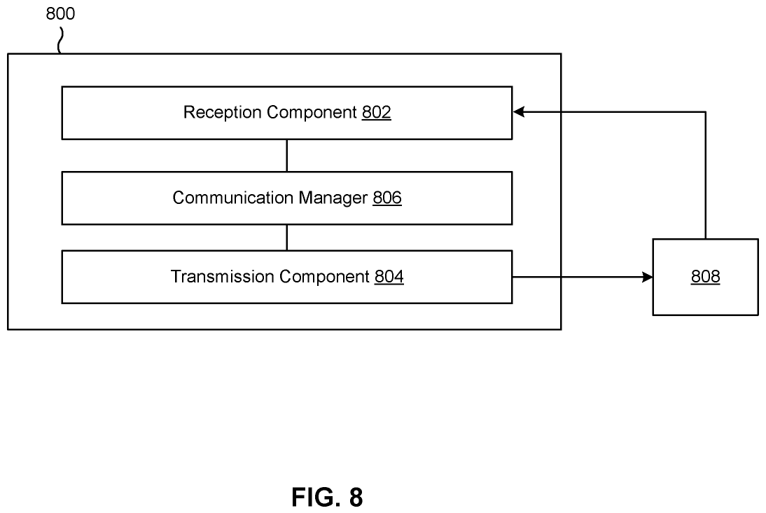

In some aspects, a UE (e.g., the UE 120 or apparatus 800 of FIG. 8) may include means for transmitting a capability message that includes at least a first parameter related to possible input for RRM prediction, measurement event prediction, or a combination thereof, and a second parameter related to possible output for RRM prediction, measurement event prediction, or a combination thereof; means for receiving a report configuration based at least in part on the first parameter and the second parameter; and means for transmitting a report according to the report configuration. Additionally, or alternatively, the UE may include means for receiving a report configuration that includes at least a first parameter indicating measurement resources for RRM prediction, measurement event prediction, or a combination thereof, and a second parameter indicating prediction resources for the RRM prediction, the measurement event prediction, or the combination thereof; and means for transmitting a prediction result for the prediction resources using the measurement resources and based on the report configuration. The means for the UE to perform operations described herein may include, for example, one or more of communication manager 150, processing system 140, a radio, one or more RF chains, one or more transceivers, one or more antennas, one or more modems, a reception component (for example, reception component 802 depicted and described in connection with FIG. 8), or a transmission component (for example, transmission component 804 depicted and described in connection with FIG. 8), among other examples.

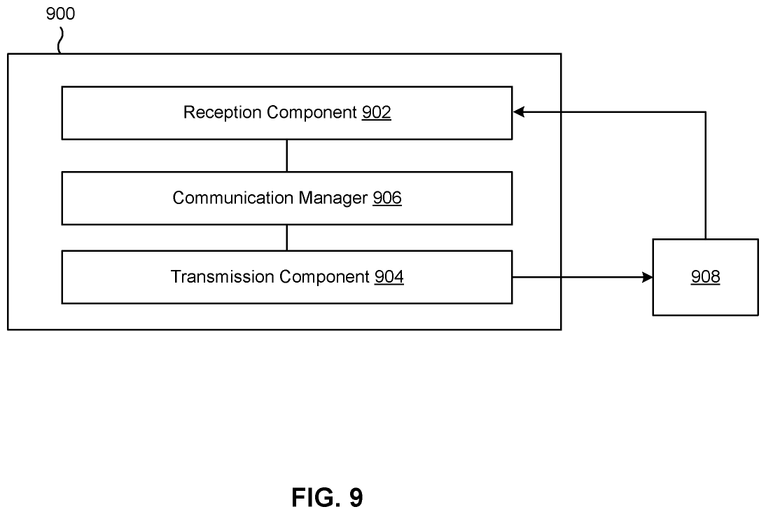

In some aspects, a network node (e.g., the network node 110, an RU, a DU, a CU, or apparatus 900 of FIG. 9) may include means for receiving a capability message, associated with a UE, that includes at least a first parameter related to possible input for RRM prediction, measurement event prediction, or a combination thereof, and a second parameter related to possible output for RRM prediction, measurement event prediction, or a combination thereof; means for transmitting a report configuration based at least in part on the first parameter and the second parameter; and means for receiving a report according to the report configuration. Additionally, or alternatively, the network node may include means for transmitting a report configuration that includes at least a first parameter indicating measurement resources for RRM prediction, measurement event prediction, or a combination thereof, and a second parameter indicating prediction resources for the RRM prediction, the measurement event prediction, or the combination thereof; and means for receiving a prediction result for the prediction resources using the measurement resources and based on the report configuration. The means for the network node to perform operations described herein may include, for example, one or more of communication manager 155, processing system 145, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

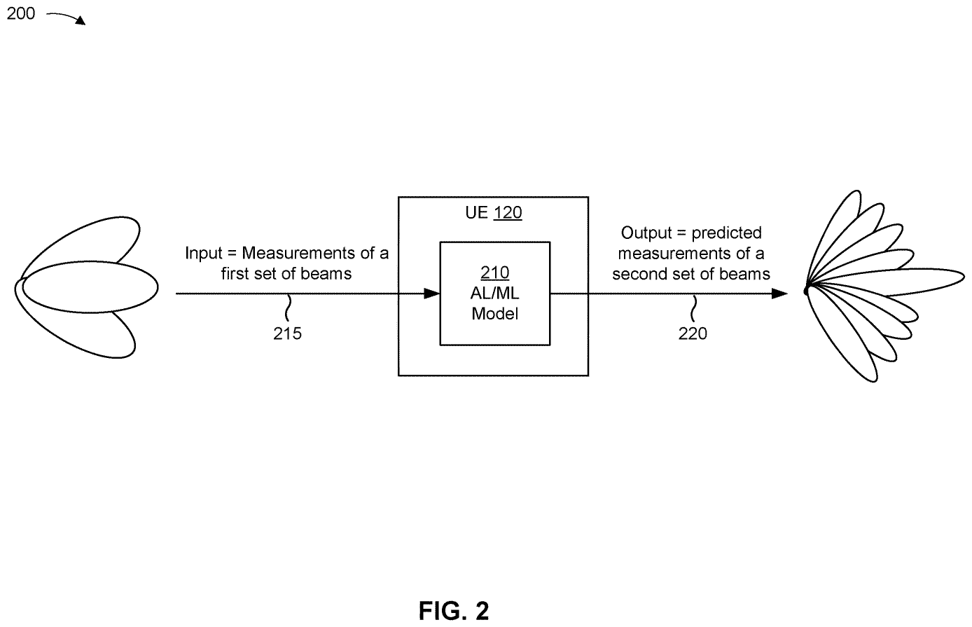

FIG. 2 is a diagram illustrating an example 200 of AI/ML based beam management. As shown in FIG. 2, an AI/ML model 210 may be deployed at or on a UE 120. For example, a model inference host (such as a model inference host) may be deployed at, or on, a UE 120. The AI/ML model 210 may enable the UE 120 to determine one or more inferences or predictions based on data input to the AI/ML model 210.

For example, as shown by reference number 215, an input to the AI/ML model 210 may include measurements associated with a first set of beams. For example, a network node 110 may transmit one or more signals using respective beams from the first set of beams. The UE 120 may perform measurements (e.g., L1 RSRP measurements or other measurements) of the first set of beams to obtain a first set of measurements. For example, each beam, from the first set of beams, may be associated with one or more measurements performed by the UE 120. The UE 120 may input the first set of measurements (e.g., L1 RSRP measurement values) into the AI/ML model 210 along with information associated with the first set of beams or a second set of beams, such as a beam direction (e.g., spatial direction), beam width, beam shape, or other characteristics of the respective beams from the first set of beams or the second set of beams.

As shown by reference number 220, the AI/ML model 210 may output one or more predictions. The one or more predictions may include predicted measurement values (e.g., predicted L1 RSRP measurement values) associated with the second set of beams. This may reduce a quantity of beam measurements that are performed by the UE 120, thereby conversing power of the UE 120 and network resources that would have otherwise been used to measure all beams included in the first set of beams and the second set of beams. This type of prediction may be referred to as a codebook based spatial domain selection or prediction.

As another example, an output of the AI/ML model 210 may include a point-direction, an angle of departure (AoD), and/or an angle of arrival (AoA) of a beam included in the second set of beams. This type of prediction may be referred to as a non-codebook based spatial domain selection or prediction. As another example, multiple measurement report or values, collected at different points in time, may be input to the AI/ML model 210. This may enable the AI/ML model 210 to output codebook based or non-codebook based predictions for a measurement value, an AoD, and/or an AoA, among other examples, of a beam at a future time. The output(s) of the AI/ML model 210, as described herein, may facilitate initial access procedures, secondary cell group (SCG) setup procedures, beam refinement procedures (e.g., a P2 beam management procedure or a P3 beam management procedure), link quality or interference adaptation procedure, beam failure and/or beam blockage predictions, or radio link failure predictions, among other examples.

In some examples, the first set of beams may be referred to as Set B beams and the second set of beams may be referred to as Set A beams. In some examples, the first set of beams (e.g., the Set B beams) may be a subset of the second set of beams (e.g., the Set A beams). In some other examples, the first set of beams and the second set of beams may be different beams or may be mutually exclusive sets. For example, the first set of beams (e.g., the Set B beams) may include wide beams (e.g., unrefined beams or beams having a beam width that satisfies a first threshold) and the second set of beams (e.g., the Set A beams) may include narrow beams (e.g., refined beams or beams having a beam width that satisfies a second threshold). In one example, the AI/ML model 210 may perform spatial-domain beam predictions for beams included in the Set A beams based on measurement results of beams included in the Set B beams. As another example, the AI/ML model 210 may perform temporal beam prediction for beams included in the Set A beams based on historic measurement results of beams included in the Set B beams.

Although the example 200 is described in connection with beam prediction, the UE 120 may similarly apply an AI/ML model for mobility prediction. For example, the UE 120 may input, to the AI/ML model, at least one measurement from a serving cell or a neighboring cell and receive, as output from the AI/ML model, a cell prediction (e.g., top M cells, where M is a positive integer), a beam prediction (e.g., top K beams, where K is a positive integer), or a measurement event prediction (e.g., prediction that an A1 event, an A2 event, an A3 event, an A4 event, an A5 event, or an A6 event, as defined in 3GPP specifications, is likely to occur).

Typically, the UE 120 may have limitations related to mobility prediction (e.g., due to hardware constraints, software constraints, or a combination thereof). Therefore, the UE 120 will generally reject a configuration from the network, associated with mobility prediction, if the configuration exceeds a capability of the UE 120. In some aspects described herein, the UE 120 may transmit a capability message, associated with RRM prediction, measurement event prediction, or a combination thereof, to the network node 110. Therefore, the network node 110 may only provide report configurations that are within a capability of the UE 120. As a result, power, processing resources, and network resources are conserved that otherwise would have been wasted if the network node 110 were to provide an unsupported configuration for mobility prediction to the UE 120.

As indicated above, FIG. 2 is provided as an example. Other examples may differ from what is described with regard to FIG. 2.

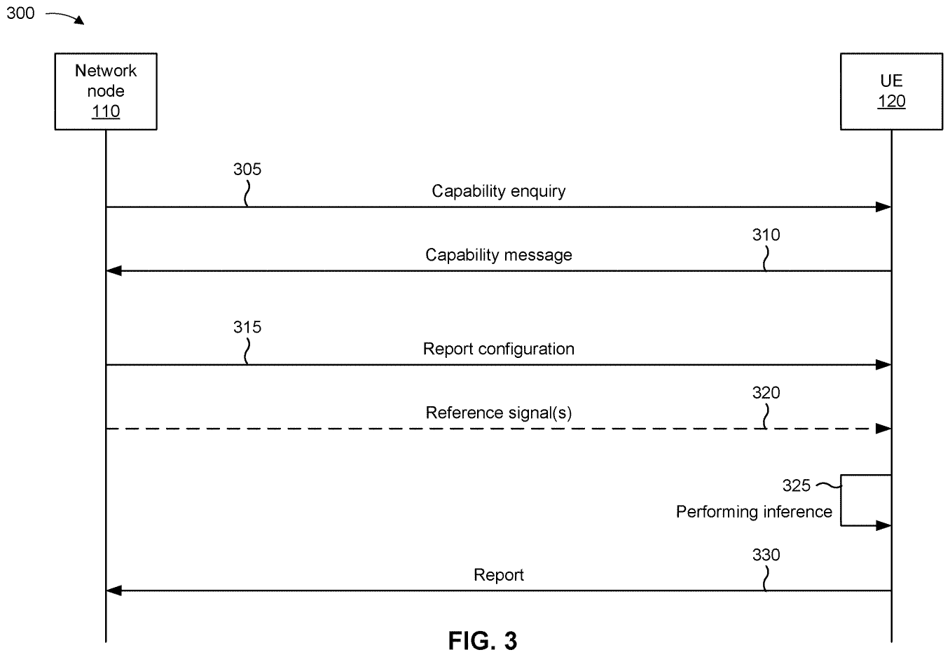

FIG. 3 is a diagram illustrating an example 300 associated with reporting capability for mobility prediction. As shown in FIG. 3, a network node 110 (e.g., an RU or a device controlling the RU, such as a DU or a CU) and a UE 120 may communicate with one another (e.g., OTA in a wireless network, such as the wireless communication network 100 of FIG. 1).

As shown by reference number 305, the network node 110 may transmit, and the UE 120 may receive, a capability enquiry. The capability enquiry may request information associated with mobility prediction at the UE 120. The capability enquiry may include an RRC message. For example, the capability enquiry may include a UECapabilityEnquiry message, as defined in 3GPP specifications.

As shown by reference number 310, the UE 120 may transmit, and the network node 110 may receive, a capability message. The UE 120 may transmit, and the network node 110 may receive, the capability message in response to the capability enquiry. The capability message may include an RRC message. For example, the capability message may include a UECapabilityInformation message, as defined in 3GPP specifications.

In some aspects, the capability message may indicate general capabilities associated with mobility prediction. As used herein, “mobility prediction” may refer to RRM predictions (e.g., serving cell predictions, intra-frequency predictions, or inter-frequency predictions), measurement event predictions, or a combination thereof. The UE 120 may therefore include, in the capability message, a first parameter (related to possible input) indicating a type of reference signal supported by the UE 120 (e.g., SSBs, CSI-RSs, or a combination thereof). Additionally, or alternatively, the first parameter may indicate a maximum number of cells that the UE 120 can measure across frequencies, a maximum number of cells that the UE 120 can measure for intra-frequency prediction, a maximum number of cells that the UE 120 can measure for inter-frequency prediction, a maximum number of beams that the UE 120 can measure across cells and across frequencies, a maximum number of beams that the UE 120 can measure across cells in a serving frequency, a maximum number of beams that the UE 120 can measure per cell in a serving frequency, a maximum number of beams the UE 120 can measure in a serving cell, a maximum number of beams the UE 120 can measure per cell for intra-frequency prediction, a maximum number of beams that the UE 120 can measure per cell for intra-frequency prediction, or a combination thereof.

The UE 120 may also include, in the capability message, a second parameter (related to possible output) indicating whether the UE 120 supports a measurement set equal to a prediction set, a measurement set that is a subset of the prediction set, a measurement set that is different from the prediction set, or a combination thereof. Additionally, or alternatively, the second parameter may indicate whether the UE 120 supports top beam prediction, top cell prediction, top beam prediction with predicted measurements, top beam prediction with confidence values, top cell prediction with predicted measurements, top cell prediction with confidence values, or a combination thereof. Additionally, or alternatively, the second parameter may indicate a maximum number of cells that the UE 120 can predict across frequencies, a maximum number of cells that the UE 120 can predict for intra-frequency prediction, a maximum number of cells that the UE 120 can predict for inter-frequency prediction, a maximum number of cells that the UE 120 can predict for inter-frequency prediction, a maximum number of beams that the UE 120 can predict across cells and across frequencies, a maximum number of beams that the UE 120 can predict across cells in a serving frequency, a maximum number of beams that the UE 120 can predict per cell in a serving frequency, a maximum number of beams that the UE 120 can predict at a serving cell, a maximum number of beams that the UE 120 can predict per cell for intra-frequency prediction, a maximum number of beams that the UE 120 can predict per cell for inter-frequency prediction, or a combination thereof.

For serving cell prediction (and serving cell beam prediction), the UE 120 may include, in the capability message, a second parameter (related to possible output) indicating a prediction related capability. For example, the second parameter may indicate a maximum number of beams of the serving cell that the UE 120 can predict, a maximum number of measurements at the serving cell that the UE 120 can predict, whether the UE 120 supports cell quality prediction, which measurement events are supported by the UE 120, or a combination thereof. For temporal prediction, the second parameter may further indicate a total number of beams of the serving cell, that the UE 120 can predict, across instances.

The UE 120 may also include, in the capability message, a first parameter (related to possible input) indicating a measurement related capability. For example, the first parameter may indicate a maximum number of beams of the serving cell that the UE 120 can measure, a minimum number of beams of the serving cell that the UE 120 can measure, a maximum number of neighboring cells that the UE 120 can measure, whether the UE 120 supports use of neighboring cells measurements, a minimum number of neighboring cells that the UE 120 can measure, a maximum number of beams per neighboring cell that the UE 120 can measure, whether the UE 120 supports use of beam measurements from neighboring cells, a minimum number of beams per neighboring cell that the UE 120 can measure, a maximum number of beams across the neighboring cells that the UE 120 can measure, a minimum number of beams across the neighboring cells that the UE 120 can measure, or a combination thereof. For temporal prediction, the first parameter may further indicate a minimum number of measurement instances for the serving cell, a minimum number of measurement instances for neighboring cells, a measurement periodicity for the serving cell, a measurement periodicity for neighboring cells, a prediction window for the serving cell, or a combination thereof.

For intra-frequency neighboring cell prediction (and neighboring cell beam prediction), the UE 120 may include, in the capability message, a second parameter (related to possible output) indicating a prediction related capability. For example, the second parameter may indicate a maximum number of beams across neighboring cells that the UE 120 can predict, a maximum number of beams per neighboring cell that the UE 120 can predict, a maximum number of measurements across neighboring cells that the UE 120 can predict, a maximum number of measurements per neighboring cell that the UE 120 can predict, whether the UE 120 supports cell quality prediction, which measurement events are supported by the UE 120, or a combination thereof. For temporal prediction, the second parameter may further indicate a total number of beams of the neighboring cell, that the UE 120 can predict, across instances.

The UE 120 may also include, in the capability message, a first parameter (related to possible input) indicating a measurement related capability. For example, the first parameter may indicate a maximum number of beams of the neighboring cell that the UE 120 can measure, a minimum number of beams of the neighboring cell that the UE 120 can measure, a maximum number of other neighboring cells that the UE 120 can measure, a minimum number of other neighboring cells that the UE 120 can measure, a maximum number of beams per other neighboring cell that the UE 120 can measure, a minimum number of beams per other neighboring cell that the UE 120 can measure, a maximum number of beams across all neighboring cells that the UE 120 can measure, or a combination thereof.

For inter-frequency neighboring cell prediction (and neighboring cell beam prediction), the UE 120 may include, in the capability message, a second parameter (related to possible output) indicating a prediction related capability. For example, the second parameter may indicate a list of frequencies that the UE 120 can predict for inter-frequency prediction, a range of frequencies that the UE 120 can predict for inter-frequency prediction, or a combination thereof. Alternatively, the second parameter may indicate a maximum number of beams across neighboring cells that the UE 120 can predict, a maximum number of beams per neighboring cell that the UE 120 can predict, a maximum number of measurements across neighboring cells that the UE 120 can predict, a maximum number of measurements per neighboring cell that the UE 120 can predict, whether the UE 120 supports cell quality prediction, which measurement events are supported by the UE 120, or a combination thereof. For temporal prediction, the second parameter may further indicate a total number of beams of the neighboring cell that the UE 120 can predict per frequency and across instances, a total number of beams of the neighboring cell that the UE 120 can predict across frequencies and across instances, a prediction window for the neighboring cell, or a combination thereof.

The UE 120 may also include, in the capability message, a first parameter (related to possible input) indicating a measurement related capability. For example, the first parameter may indicate a list of frequencies that the UE 120 can measure for inter-frequency prediction, a range of frequencies that the UE 120 can measure for inter-frequency prediction, or a combination thereof. Alternatively, the first parameter may indicate a maximum number of beams of the neighboring cell that the UE 120 can measure, a minimum number of beams of the neighboring cell that the UE 120 can measure, a maximum number of other neighboring cells on a same frequency that the UE 120 can measure, a minimum number of other neighboring cells on the same frequency that the UE 120 can measure, a maximum number of beams per other neighboring cell on the same frequency that the UE 120 can measure, a minimum number of beams per other neighboring cell on the same frequency that the UE 120 can measure, a maximum number of beams per frequency that the UE 120 can measure, a maximum number of other neighboring cells on different frequencies that the UE 120 can measure, a minimum number of other neighboring cells on different frequencies that the UE 120 can measure, a maximum number of beams per other neighboring cell on different frequencies that the UE 120 can measure, a minimum number of beams per other neighboring cell on different frequencies that the UE 120 can measure, a maximum number of beams across frequencies that the UE 120 can measure, or a combination thereof. For temporal prediction, the first parameter may further indicate a minimum number of measurement instances on a same frequency, a minimum number of measurement instances across frequencies, a measurement periodicity for a same frequency, a measurement periodicity for other frequencies, or a combination thereof.

For measurement event prediction, in addition to parameters described above, the UE 120 may indicate a maximum prediction window length or a minimum prediction window length for measurement event prediction, a number of predicted instances (e.g., a maximum number or a minimum number or a range of numbers) and a time between the predicted instances (e.g., a maximum time or a minimum time or a range of times) supported by the UE 120, whether the UE 120 supports probability reporting with measurement event prediction, or a combination thereof. The UE 120 may perform measurement event prediction (e.g., as described in greater detail below) directly (e.g., using actual cell or beam measurements) or indirectly (e.g., using predicted cell or beam measurements). For measurement event prediction, a first parameter (related to possible input) may indicate a maximum number of beams of a serving cell that the UE 120 can measure, a minimum number of beams of the serving cell that the UE 120 can measure, a maximum number of beams of a target cell that the UE 120 can measure, a minimum number of beams of the target cell that the UE 120 can measure, a maximum number of beams of neighboring cells that the UE 120 can measure, a minimum number of beams of the neighboring cells that the UE 120 can measure, a maximum number of measurements that the UE 120 can perform for the serving cell, a minimum number of measurements that the UE 120 can perform for the serving cell, a maximum number of measurements that the UE 120 can perform for the target cell, a minimum number of measurements that the UE 120 can perform for the target cell, a maximum number of measurements that the UE 120 can perform for the neighboring cells, a minimum number of measurements that the UE 120 can perform for the neighboring cells, a maximum number of beams of an SCell that the UE 120 can measure, a minimum number of beams of the SCell that the UE 120 can measure, a maximum number of measurements that the UE 120 can perform for the SCell, a minimum number of measurements that the UE 120 can perform for the SCell, or a combination thereof.

Any of the parameters described above may be reported jointly for serving cell prediction, inter-frequency prediction, intra-frequency prediction, or measurement event prediction. Alternatively, the UE 120 may report different parameters for different types of mobility prediction. Similarly, any of the parameters described above may be reported jointly for temporal prediction and spatial prediction. Alternatively, the UE 120 may report different parameters for temporal prediction as compared with spatial prediction. For temporal prediction, the first parameter may further indicate a minimum number of measurement instances for intra-frequency prediction, a measurement periodicity for intra-frequency prediction, a prediction window for the neighboring cell, or a combination thereof.

As shown by reference number 315, the network node 110 may transmit, and the UE 120 may receive, a report configuration. The report configuration may request a report with a cell prediction, a beam prediction, a measurement event prediction, or a combination thereof, from the UE 120. The capability enquiry may include an RRC message. For example, the report configuration may include a ReportConfigNR message, as defined in 3GPP specifications. The report configuration may be based at least in part on the capability message (e.g., the first and second parameters indicated therein). In other words, the network node 110 may generate the report configuration consistent with capabilities reported by the UE 120. As a result, the network node 110 conserves power, processing resources, and network resources that would otherwise have been wasted if the network node 110 were to provide an unsupported report configuration to the UE 120.

In some aspects, as shown by reference number 320, the network node 110 may transmit, and the UE 120 may measure, at least one reference signal. For example, the UE 120 may use a measurement from a serving cell (including the network node 110) to derive a serving cell prediction (e.g., a prediction of which beams in the serving cell are or will be associated with greater signal strength, a prediction of current or future measurements of the beams, or a prediction of cell quality for the serving cell). In another example, the UE 120 may use a measurement from the serving cell to derive a neighboring cell prediction (e.g., a prediction of which cells are or will be associated with greater signal strength, a prediction of current or future measurements of the cells, a prediction of which beams in neighboring cells are or will be associated with greater signal strength, a prediction of current or future measurements of the beams, or a prediction of cell quality for the neighboring cells).

Additionally, or alternatively, the UE 120 may measure at least one reference signal from a neighboring cell. For example, the UE 120 may use a measurement from the neighboring cell in a same frequency to derive an intra-frequency prediction (e.g., a prediction of which cells are or will be associated with greater signal strength, a prediction of current or future measurements of the cells, a prediction of which beams in neighboring cells are or will be associated with greater signal strength, a prediction of current or future measurements of the beams, or a prediction of cell quality for the neighboring cells).

As shown by reference number 325, the UE 120 may perform inference using the measurement(s) described above. For example, the UE 120 may perform inference to derive a cell prediction, a beam prediction, or a combination thereof (whether for the serving cell, for an intra-frequency neighboring cell, or an inter-frequency neighboring cell). Additionally, or alternatively, the UE 120 may perform inference to derive a measurement event prediction. In one example, the UE 120 may predict an A1 or A2 event for the serving cell. In another example, the UE 120 may predict an A3, an A4, or an A5 event for a target cell (e.g., relative to the serving cell). In another example, the UE 120 may predict an A6 event for a target cell (e.g., relative to an SCell).

In some aspects, the UE 120 may perform inference using a previous prediction (in addition to, or in lieu of, using the measurement(s) described above). For example, the UE 120 may perform inference, using a cell prediction or a beam prediction, to derive a measurement event prediction. Therefore, the UE 120 may predict a measurement event based at least in part on a predicted signal strength for a beam or a cell.

As shown by reference number 330, the UE 120 may transmit, and the network node 110 may receive, a report indicating the cell prediction, the beam prediction, the measurement event prediction, or a combination thereof. Therefore, the network node 110 may perform SCell addition (or removal) or handover, among other examples, in response to the cell prediction, the beam prediction, or the measurement event prediction. As a result, the network node 110 may speed up SCell addition (or removal) or handover by using predictions (e.g., of the future) rather than waiting for measurements.

As indicated above, FIG. 3 is provided as an example. Other examples may differ from what is described with respect to FIG. 3.

FIG. 4 is a diagram illustrating an example process 400 performed, for example, at a UE or an apparatus of a UE. Example process 400 is an example where the apparatus or the UE (e.g., UE 120) performs operations associated with reporting capability for mobility prediction.

As shown in FIG. 4, in some aspects, process 400 may include transmitting a capability message that includes at least a first parameter related to possible input for RRM prediction, measurement event prediction, or a combination thereof, and a second parameter related to possible output for RRM prediction, measurement event prediction, or a combination thereof (block 410). For example, the UE (e.g., using transmission component 804 or communication manager 806, depicted in FIG. 8) may transmit a capability message that includes at least a first parameter related to possible input for RRM prediction, measurement event prediction, or a combination thereof, and a second parameter related to possible output for RRM prediction, measurement event prediction, or a combination thereof, as described herein.

As further shown in FIG. 4, in some aspects, process 400 may include receiving a report configuration based at least in part on the first parameter and the second parameter (block 420). For example, the UE (e.g., using reception component 802 or communication manager 806, depicted in FIG. 8) may receive a report configuration based at least in part on the first parameter and the second parameter, as described herein.

As further shown in FIG. 4, in some aspects, process 400 may include transmitting a report according to the report configuration (block 430). For example, the UE (e.g., using transmission component 804 or communication manager 806) may transmit a report according to the report configuration, as described herein.

Process 400 may include additional aspects, such as any single aspect or any combination of aspects described below or in connection with one or more other processes described elsewhere herein.

In a first aspect, the first parameter indicates whether the UE supports SSBs, CSI-RSs, or a combination thereof.

In a second aspect, alone or in combination with the first aspect, the second parameter indicates whether the UE supports a measurement set equal to a prediction set, a measurement set that is a subset of the prediction set, a measurement set that is different from the prediction set, or a combination thereof.

In a third aspect, alone or in combination with one or more of the first and second aspects, the first parameter indicates a maximum number of cells for measurement across frequencies, a maximum number of cells for intra-frequency measurement, a maximum number of cells for inter-frequency measurement, a maximum number of beams for measurement across cells and across frequencies, a maximum number of beams for measurement across cells in a serving frequency, a maximum number of beams for measurement per cell in a serving frequency, a maximum number of beams for measurement at a serving cell, a maximum number of beams per cell for intra-frequency measurement, a maximum number of beams per cell for inter-frequency measurement, or a combination thereof.

In a fourth aspect, alone or in combination with one or more of the first through third aspects, the second parameter indicates a maximum number of cells for prediction across frequencies, a maximum number of cells for intra-frequency prediction, a maximum number of cells for inter-frequency prediction, a maximum number of cells for inter-frequency prediction, a maximum number of beams for prediction across cells and across frequencies, a maximum number of beams for prediction across cells in a serving frequency, a maximum number of beams for prediction per cell in a serving frequency, a maximum number of beams for prediction at a serving cell, a maximum number of beams per cell for intra-frequency prediction, a maximum number of beams per cell for inter-frequency prediction, or a combination thereof.

In a fifth aspect, alone or in combination with one or more of the first through fourth aspects, the second parameter indicates whether the UE supports top beam prediction, top cell prediction, top beam prediction with predicted measurements, top cell prediction with predicted measurements, or a combination thereof.

In a sixth aspect, alone or in combination with one or more of the first through fifth aspects, the first and second parameters are associated with serving cell prediction and serving cell beam prediction for RRM.

In a seventh aspect, alone or in combination with one or more of the first through sixth aspects, the first parameter indicates a maximum number of beams of the serving cell to measure, a minimum number of beams of the serving cell to measure, a maximum number of neighboring cells to measure, whether the UE supports use of neighboring cells measurements, a minimum number of neighboring cells to measure, a maximum number of beams per neighboring cell to measure, whether the UE supports use of beam measurements from neighboring cells, a minimum number of beams per neighboring cell to measure, a maximum number of beams across the neighboring cells to measure, a minimum number of beams across the neighboring cells to measure, or a combination thereof.

In an eighth aspect, alone or in combination with one or more of the first through seventh aspects, the second parameter indicates a maximum number of beams of the serving cell to predict, a maximum number of measurements at the serving cell to predict, whether the UE supports cell quality prediction, which measurement events are supported by the UE, or a combination thereof.

In a ninth aspect, alone or in combination with one or more of the first through eighth aspects, the second parameter indicates a total number of beams of the serving cell, for prediction, across instances.

In a tenth aspect, alone or in combination with one or more of the first through ninth aspects, the first parameter indicates a minimum number of measurement instances for the serving cell, a minimum number of measurement instances for neighboring cells, a measurement periodicity for the serving cell, a measurement periodicity for neighboring cells, a prediction window for the serving cell, or a combination thereof.

In an eleventh aspect, alone or in combination with one or more of the first through tenth aspects, the first and second parameters are associated with intra-frequency neighboring cell prediction and neighboring cell beam prediction for RRM.

In a twelfth aspect, alone or in combination with one or more of the first through eleventh aspects, the first parameter indicates a maximum number of beams of the neighboring cell to measure, a minimum number of beams of the neighboring cell to measure, a maximum number of other neighboring cells to measure, a minimum number of other neighboring cells to measure, a maximum number of beams per other neighboring cell to measure, a minimum number of beams per other neighboring cell to measure, a maximum number of beams across all neighboring cells to measure, or a combination thereof.

In a thirteenth aspect, alone or in combination with one or more of the first through twelfth aspects, the second parameter indicates a maximum number of beams across neighboring cells to predict, a maximum number of beams per neighboring cell to predict, a maximum number of measurements across neighboring cells to predict, a maximum number of measurements per neighboring cell to predict, whether the UE supports cell quality prediction, which measurement events are supported by the UE, or a combination thereof.

In a fourteenth aspect, alone or in combination with one or more of the first through thirteenth aspects, the second parameter indicates a total number of beams of the neighboring cell, for prediction, across instances.

In a fifteenth aspect, alone or in combination with one or more of the first through fourteenth aspects, the first parameter indicates a minimum number of measurement instances for intra-frequency prediction, a measurement periodicity for intra-frequency prediction, a prediction window for the neighboring cell, or a combination thereof.

In a sixteenth aspect, alone or in combination with one or more of the first through fifteenth aspects, the first and second parameters are associated with inter-frequency neighboring cell prediction and neighboring cell beam prediction for RRM.

In a seventeenth aspect, alone or in combination with one or more of the first through sixteenth aspects, the first parameter indicates a list of frequencies to measure for inter-frequency prediction, a range of frequencies to measure for inter-frequency prediction, or a combination thereof.

In an eighteenth aspect, alone or in combination with one or more of the first through seventeenth aspects, the first parameter indicates a maximum number of beams of the neighboring cell to measure, a minimum number of beams of the neighboring cell to measure, a maximum number of other neighboring cells on a same frequency to measure, a minimum number of other neighboring cells on the same frequency to measure, a maximum number of beams per other neighboring cell on the same frequency to measure, a minimum number of beams per other neighboring cell on the same frequency to measure, a maximum number of beams per frequency to measure, a maximum number of other neighboring cells on different frequencies to measure, a minimum number of other neighboring cells on different frequencies to measure, a maximum number of beams per other neighboring cell on different frequencies to measure, a minimum number of beams per other neighboring cell on different frequencies to measure, a maximum number of beams across frequencies to measure, or a combination thereof.

In a nineteenth aspect, alone or in combination with one or more of the first through eighteenth aspects, the second parameter indicates a maximum number of beams across neighboring cells to predict, a maximum number of beams per neighboring cell to predict, a maximum number of measurements across neighboring cells to predict, a maximum number of measurements per neighboring cell to predict, whether the UE supports cell quality prediction, which measurement events are supported by the UE, or a combination thereof.

In a twentieth aspect, alone or in combination with one or more of the first through nineteenth aspects, the second parameter indicates a total number of beams of the neighboring cell for prediction per frequency and across instances, a total number of beams of the neighboring cell for prediction across frequencies and across instances, a prediction window for the neighboring cell, or a combination thereof.

In a twenty-first aspect, alone or in combination with one or more of the first through twentieth aspects, the first parameter indicates a minimum number of measurement instances on a same frequency, a minimum number of measurement instances across frequencies, a measurement periodicity for a same frequency, a measurement periodicity for other frequencies, or a combination thereof.

In a twenty-second aspect, alone or in combination with one or more of the first through twenty-first aspects, the second parameter indicates a maximum prediction window length or a minimum prediction window length for measurement event prediction.

In a twenty-third aspect, alone or in combination with one or more of the first through twenty-second aspects, the second parameter indicates a number of predicted instances and a time between the predicted instances supported by the UE, where the number includes a maximum number or a minimum number or is included in a range of numbers supported by the UE, and the time includes a maximum time or a minimum time or is included in a range of times supported by the UE.

In a twenty-fourth aspect, alone or in combination with one or more of the first through twenty-third aspects, the second parameter indicates whether the UE supports probability reporting with measurement event prediction.

In a twenty-fifth aspect, alone or in combination with one or more of the first through twenty-fourth aspects, the first and second parameters are associated with direct prediction for measurement event prediction.

In a twenty-sixth aspect, alone or in combination with one or more of the first through twenty-fifth aspects, the first and second parameters are associated with indirect prediction for measurement event prediction.

In a twenty-seventh aspect, alone or in combination with one or more of the first through twenty-sixth aspects, the first parameter indicates a maximum number of beams of a serving cell to measure, a minimum number of beams of the serving cell to measure, a maximum number of beams of a target cell to measure, a minimum number of beams of the target cell to measure, a maximum number of beams of neighboring cells to measure, a minimum number of beams of the neighboring cells to measure, a maximum number of measurements to perform for the serving cell, a minimum number of measurements to perform for the serving cell, a maximum number of measurements to perform for the target cell, a minimum number of measurements to perform for the target cell, a maximum number of measurements to perform for the neighboring cells, a minimum number of measurements to perform for the neighboring cells, a maximum number of beams of an SCell to measure, a minimum number of beams of the SCell to measure, a maximum number of measurements to perform for the SCell, a minimum number of measurements to perform for the SCell, or a combination thereof.

Although FIG. 4 shows example blocks of process 400, in some aspects, process 400 may include additional blocks, fewer blocks, different blocks, or differently arranged blocks than those depicted in FIG. 4. Additionally, or alternatively, two or more of the blocks of process 400 may be performed in parallel.

FIG. 5 is a diagram illustrating an example process 500 performed, for example, at a network node or an apparatus of a network node. Example process 500 is an example where the apparatus or the network node (e.g., network node 110) performs operations associated with reporting capability for mobility prediction.

As shown in FIG. 5, in some aspects, process 500 may include receiving a capability message, associated with a UE, that includes at least a first parameter related to possible input for RRM prediction, measurement event prediction, or a combination thereof, and a second parameter related to possible output for RRM prediction, measurement event prediction, or a combination thereof (block 510). For example, the network node (e.g., using reception component 902 or communication manager 906, depicted in FIG. 9) may receive a capability message, associated with a UE, that includes at least a first parameter related to possible input for RRM prediction, measurement event prediction, or a combination thereof, and a second parameter related to possible output for RRM prediction, measurement event prediction, or a combination thereof, as described herein.

As further shown in FIG. 5, in some aspects, process 500 may include transmitting a report configuration based at least in part on the first parameter and the second parameter (block 520). For example, the network node (e.g., using transmission component 904 or communication manager 906, depicted in FIG. 9) may transmit a report configuration based at least in part on the first parameter and the second parameter, as described herein.

As further shown in FIG. 5, in some aspects, process 500 may include receiving a report according to the report configuration (block 530). For example, the network node (e.g., using reception component 902 or communication manager 906) may receive a report according to the report configuration, as described herein.

Process 500 may include additional aspects, such as any single aspect or any combination of aspects described below or in connection with one or more other processes described elsewhere herein.

In a first aspect, the first parameter indicates whether the UE supports SSBs, CSI-RSs, or a combination thereof.

In a second aspect, alone or in combination with the first aspect, the second parameter indicates whether the UE supports a measurement set equal to a prediction set, a measurement set that is a subset of the prediction set, a measurement set that is different from the prediction set, or a combination thereof.

In a third aspect, alone or in combination with one or more of the first and second aspects, the first parameter indicates a maximum number of cells for measurement across frequencies, a maximum number of cells for intra-frequency measurement, a maximum number of cells for inter-frequency measurement, a maximum number of beams for measurement across cells and across frequencies, a maximum number of beams for measurement across cells in a serving frequency, a maximum number of beams for measurement per cell in a serving frequency, a maximum number of beams for measurement at a serving cell, a maximum number of beams per cell for intra-frequency measurement, a maximum number of beams per cell for inter-frequency measurement, or a combination thereof.

In a fourth aspect, alone or in combination with one or more of the first through third aspects, the second parameter indicates a maximum number of cells for prediction across frequencies, a maximum number of cells for intra-frequency prediction, a maximum number of cells for inter-frequency prediction, a maximum number of cells for inter-frequency prediction, a maximum number of beams for prediction across cells and across frequencies, a maximum number of beams for prediction across cells in a serving frequency, a maximum number of beams for prediction per cell in a serving frequency, a maximum number of beams for prediction at a serving cell, a maximum number of beams per cell for intra-frequency prediction, a maximum number of beams per cell for inter-frequency prediction, or a combination thereof.

In a fifth aspect, alone or in combination with one or more of the first through fourth aspects, the second parameter indicates whether the UE supports top beam prediction, top cell prediction, top beam prediction with predicted measurements, top cell prediction with predicted measurements, or a combination thereof.

In a sixth aspect, alone or in combination with one or more of the first through fifth aspects, the first and second parameters are associated with serving cell prediction and serving cell beam prediction for RRM.

In a seventh aspect, alone or in combination with one or more of the first through sixth aspects, the first parameter indicates a maximum number of beams of the serving cell to measure, a minimum number of beams of the serving cell to measure, a maximum number of neighboring cells to measure, whether the UE supports use of neighboring cells measurements, a minimum number of neighboring cells to measure, a maximum number of beams per neighboring cell to measure, whether the UE supports use of beam measurements from neighboring cells, a minimum number of beams per neighboring cell to measure, a maximum number of beams across the neighboring cells to measure, a minimum number of beams across the neighboring cells to measure, or a combination thereof.

In an eighth aspect, alone or in combination with one or more of the first through seventh aspects, the second parameter indicates a maximum number of beams of the serving cell to predict, a maximum number of measurements at the serving cell to predict, whether the UE supports cell quality prediction, which measurement events are supported by the UE, or a combination thereof.

In a ninth aspect, alone or in combination with one or more of the first through eighth aspects, the second parameter indicates a total number of beams of the serving cell, for prediction, across instances.

In a tenth aspect, alone or in combination with one or more of the first through ninth aspects, the first parameter indicates a minimum number of measurement instances for the serving cell, a minimum number of measurement instances for neighboring cells, a measurement periodicity for the serving cell, a measurement periodicity for neighboring cells, a prediction window for the serving cell, or a combination thereof.

In an eleventh aspect, alone or in combination with one or more of the first through tenth aspects, the first and second parameters are associated with intra-frequency neighboring cell prediction and neighboring cell beam prediction for RRM.

In a twelfth aspect, alone or in combination with one or more of the first through eleventh aspects, the first parameter indicates a maximum number of beams of the neighboring cell to measure, a minimum number of beams of the neighboring cell to measure, a maximum number of other neighboring cells to measure, a minimum number of other neighboring cells to measure, a maximum number of beams per other neighboring cell to measure, a minimum number of beams per other neighboring cell to measure, a maximum number of beams across all neighboring cells to measure, or a combination thereof.

In a thirteenth aspect, alone or in combination with one or more of the first through twelfth aspects, the second parameter indicates a maximum number of beams across neighboring cells to predict, a maximum number of beams per neighboring cell to predict, a maximum number of measurements across neighboring cells to predict, a maximum number of measurements per neighboring cell to predict, whether the UE supports cell quality prediction, which measurement events are supported by the UE, or a combination thereof.

In a fourteenth aspect, alone or in combination with one or more of the first through thirteenth aspects, the second parameter indicates a total number of beams of the neighboring cell, for prediction, across instances.

In a fifteenth aspect, alone or in combination with one or more of the first through fourteenth aspects, the first parameter indicates a minimum number of measurement instances for intra-frequency prediction, a measurement periodicity for intra-frequency prediction, a prediction window for the neighboring cell, or a combination thereof.

In a sixteenth aspect, alone or in combination with one or more of the first through fifteenth aspects, the first and second parameters are associated with inter-frequency neighboring cell prediction and neighboring cell beam prediction for RRM.

In a seventeenth aspect, alone or in combination with one or more of the first through sixteenth aspects, the first parameter indicates a list of frequencies to measure for inter-frequency prediction, a range of frequencies to measure for inter-frequency prediction, or a combination thereof.

In an eighteenth aspect, alone or in combination with one or more of the first through seventeenth aspects, the first parameter indicates a maximum number of beams of the neighboring cell to measure, a minimum number of beams of the neighboring cell to measure, a maximum number of other neighboring cells on a same frequency to measure, a minimum number of other neighboring cells on the same frequency to measure, a maximum number of beams per other neighboring cell on the same frequency to measure, a minimum number of beams per other neighboring cell on the same frequency to measure, a maximum number of beams per frequency to measure, a maximum number of other neighboring cells on different frequencies to measure, a minimum number of other neighboring cells on different frequencies to measure, a maximum number of beams per other neighboring cell on different frequencies to measure, a minimum number of beams per other neighboring cell on different frequencies to measure, a maximum number of beams across frequencies to measure, or a combination thereof.

In a nineteenth aspect, alone or in combination with one or more of the first through eighteenth aspects, the second parameter indicates a maximum number of beams across neighboring cells to predict, a maximum number of beams per neighboring cell to predict, a maximum number of measurements across neighboring cells to predict, a maximum number of measurements per neighboring cell to predict, whether the UE supports cell quality prediction, which measurement events are supported by the UE, or a combination thereof.

In a twentieth aspect, alone or in combination with one or more of the first through nineteenth aspects, the second parameter indicates a total number of beams of the neighboring cell for prediction per frequency and across instances, a total number of beams of the neighboring cell for prediction across frequencies and across instances, a prediction window for the neighboring cell, or a combination thereof.

In a twenty-first aspect, alone or in combination with one or more of the first through twentieth aspects, the first parameter indicates a minimum number of measurement instances on a same frequency, a minimum number of measurement instances across frequencies, a measurement periodicity for a same frequency, a measurement periodicity for other frequencies, or a combination thereof.

In a twenty-second aspect, alone or in combination with one or more of the first through twenty-first aspects, the second parameter indicates a maximum prediction window length or a minimum prediction window length for measurement event prediction.

In a twenty-third aspect, alone or in combination with one or more of the first through twenty-second aspects, the second parameter indicates a number of predicted instances and a time between the predicted instances supported by the UE, where the number includes a maximum number or a minimum number or is included in a range of numbers supported by the UE, and the time includes a maximum time or a minimum time or is included in a range of times supported by the UE.

In a twenty-fourth aspect, alone or in combination with one or more of the first through twenty-third aspects, the second parameter indicates whether the UE supports probability reporting with measurement event prediction.

In a twenty-fifth aspect, alone or in combination with one or more of the first through twenty-fourth aspects, the first and second parameters are associated with direct prediction for measurement event prediction.

In a twenty-sixth aspect, alone or in combination with one or more of the first through twenty-fifth aspects, the first and second parameters are associated with indirect prediction for measurement event prediction.

In a twenty-seventh aspect, alone or in combination with one or more of the first through twenty-sixth aspects, the first parameter indicates a maximum number of beams of a serving cell to measure, a minimum number of beams of the serving cell to measure, a maximum number of beams of a target cell to measure, a minimum number of beams of the target cell to measure, a maximum number of beams of neighboring cells to measure, a minimum number of beams of the neighboring cells to measure, a maximum number of measurements to perform for the serving cell, a minimum number of measurements to perform for the serving cell, a maximum number of measurements to perform for the target cell, a minimum number of measurements to perform for the target cell, a maximum number of measurements to perform for the neighboring cells, a minimum number of measurements to perform for the neighboring cells, a maximum number of beams of an SCell to measure, a minimum number of beams of the SCell to measure, a maximum number of measurements to perform for the SCell, a minimum number of measurements to perform for the SCell, or a combination thereof.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, at a UE or an apparatus of a UE. Example process 600 is an example where the apparatus or the UE (e.g., UE 120) performs operations associated with mobility prediction.

As shown in FIG. 6, in some aspects, process 600 may include receiving a report configuration that includes at least a first parameter indicating measurement resources for RRM prediction, measurement event prediction, or a combination thereof, and a second parameter indicating prediction resources for the RRM prediction, the measurement event prediction, or the combination thereof (block 610). For example, the UE (e.g., using reception component 802 or communication manager 806, depicted in FIG. 8) may receive a report configuration that includes at least a first parameter indicating measurement resources for RRM prediction, measurement event prediction, or a combination thereof, and a second parameter indicating prediction resources for the RRM prediction, the measurement event prediction, or the combination thereof, as described herein.

As further shown in FIG. 6, in some aspects, process 600 may include transmitting a prediction result for the prediction resources using the measurement resources and based on the report configuration (block 620). For example, the UE (e.g., using transmission component 804 or communication manager 806, depicted in FIG. 8) may transmit a prediction result for the prediction resources using the measurement resources and based on the report configuration, as described herein.

Process 600 may include additional aspects, such as any single aspect or any combination of aspects described below or in connection with one or more other processes described elsewhere herein.

In a first aspect, the prediction result comprises a beam prediction for a serving cell using a measurement from the serving cell, a measurement from a neighboring cell, or a combination thereof.

In a second aspect, alone or in combination with the first aspect, the prediction result comprises a cell prediction or a beam prediction for a neighboring cell using a measurement from a serving cell, a measurement from the neighboring cell, a measurement from another cell in a same frequency, or a combination thereof.

In a third aspect, alone or in combination with one or more of the first and second aspects, the prediction result comprises a cell prediction or a beam prediction for a neighboring cell using a measurement from a serving cell, a measurement from the neighboring cell, a measurement from another cell in a same frequency, a measurement from another cell in a different frequency, or a combination thereof.

In a fourth aspect, alone or in combination with one or more of the first through third aspects, the prediction result comprises an event prediction for a serving cell.

In a fifth aspect, alone or in combination with one or more of the first through fourth aspects, the prediction result comprises an event prediction for a neighboring cell.

In a sixth aspect, alone or in combination with one or more of the first through fifth aspects, the first parameter indicates: a number of cells for measurement across frequencies; a number of cells for intra-frequency measurement; a number of cells for inter-frequency measurement; a number of beams for measurement across cells and across frequencies; a number of beams for measurement across cells in a serving frequency; a number of beams for measurement per cell in the serving frequency; a number of beams for measurement at a serving cell; a number of beams per cell for intra-frequency measurement; a number of beams per cell for inter-frequency measurement; or a combination thereof.

In a seventh aspect, alone or in combination with one or more of the first through sixth aspects, the first parameter indicates: cells for measurement across frequencies; cells for intra-frequency measurement; cells for inter-frequency measurement; beams for measurement across cells and across frequencies; beams for measurement across cells in a serving frequency; beams for measurement per cell in the serving frequency; beams for measurement at a serving cell; beams per cell for intra-frequency measurement; beams per cell for inter-frequency measurement; or a combination thereof.

In an eighth aspect, alone or in combination with one or more of the first through seventh aspects, the second parameter indicates: a number of cells for prediction across frequencies; a number of cells for intra-frequency prediction; a number of cells for inter-frequency prediction; a number of beams for prediction across cells and across frequencies; a number of beams for prediction across cells in a serving frequency; a number of beams for prediction per cell in the serving frequency; a number of beams for prediction at a serving cell; a number of beams per cell for intra-frequency prediction; a number of beams per cell for inter-frequency prediction; or a combination thereof.

In a ninth aspect, alone or in combination with one or more of the first through eighth aspects, the second parameter indicates: cells for prediction across frequencies; cells for intra-frequency prediction; cells for inter-frequency prediction; beams for prediction across cells and across frequencies; beams for prediction across cells in a serving frequency; beams for prediction per cell in the serving frequency; beams for prediction at a serving cell; beams per cell for intra-frequency prediction; beams per cell for inter-frequency prediction; or a combination thereof.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a network node or an apparatus of a network node. Example process 700 is an example where the apparatus or the network node (e.g., network node 110) performs operations associated with mobility prediction.

As shown in FIG. 7, in some aspects, process 700 may include transmitting a report configuration that includes at least a first parameter indicating measurement resources for RRM prediction, measurement event prediction, or a combination thereof, and a second parameter indicating prediction resources for the RRM prediction, the measurement event prediction, or the combination thereof (block 710). For example, the network node (e.g., using transmission component 904 or communication manager 906, depicted in FIG. 9) may transmit a report configuration that includes at least a first parameter indicating measurement resources for RRM prediction, measurement event prediction, or a combination thereof, and a second parameter indicating prediction resources for the RRM prediction, the measurement event prediction, or the combination thereof, as described herein.

As further shown in FIG. 7, in some aspects, process 700 may include receiving a prediction result for the prediction resources using the measurement resources and based on the report configuration (block 720). For example, the network node (e.g., using reception component 902 or communication manager 906, depicted in FIG. 9) may receive a prediction result for the prediction resources using the measurement resources and based on the report configuration, as described herein.

Process 700 may include additional aspects, such as any single aspect or any combination of aspects described below or in connection with one or more other processes described elsewhere herein.

In a first aspect, the prediction result comprises a beam prediction for a serving cell using a measurement from the serving cell, a measurement from a neighboring cell, or a combination thereof.

In a second aspect, alone or in combination with the first aspect, the prediction result comprises a cell prediction or a beam prediction for a neighboring cell using a measurement from a serving cell, a measurement from the neighboring cell, a measurement from another cell in a same frequency, or a combination thereof.

In a third aspect, alone or in combination with one or more of the first and second aspects, the prediction result comprises a cell prediction or a beam prediction for a neighboring cell using a measurement from a serving cell, a measurement from the neighboring cell, a measurement from another cell in a same frequency, a measurement from another cell in a different frequency, or a combination thereof.

In a fourth aspect, alone or in combination with one or more of the first through third aspects, the prediction result comprises an event prediction for a serving cell.

In a fifth aspect, alone or in combination with one or more of the first through fourth aspects, the prediction result comprises an event prediction for a neighboring cell.

In a sixth aspect, alone or in combination with one or more of the first through fifth aspects, the first parameter indicates: a number of cells for measurement across frequencies; a number of cells for intra-frequency measurement; a number of cells for inter-frequency measurement; a number of beams for measurement across cells and across frequencies; a number of beams for measurement across cells in a serving frequency; a number of beams for measurement per cell in the serving frequency; a number of beams for measurement at a serving cell; a number of beams per cell for intra-frequency measurement; a number of beams per cell for inter-frequency measurement; or a combination thereof.

In a seventh aspect, alone or in combination with one or more of the first through sixth aspects, the first parameter indicates: cells for measurement across frequencies; cells for intra-frequency measurement; cells for inter-frequency measurement; beams for measurement across cells and across frequencies; beams for measurement across cells in a serving frequency; beams for measurement per cell in the serving frequency; beams for measurement at a serving cell; beams per cell for intra-frequency measurement; beams per cell for inter-frequency measurement; or a combination thereof.

In an eighth aspect, alone or in combination with one or more of the first through seventh aspects, the second parameter indicates: a number of cells for prediction across frequencies; a number of cells for intra-frequency prediction; a number of cells for inter-frequency prediction; a number of beams for prediction across cells and across frequencies; a number of beams for prediction across cells in a serving frequency; a number of beams for prediction per cell in the serving frequency; a number of beams for prediction at a serving cell; a number of beams per cell for intra-frequency prediction; a number of beams per cell for inter-frequency prediction; or a combination thereof.

In a ninth aspect, alone or in combination with one or more of the first through eighth aspects, the second parameter indicates: cells for prediction across frequencies; cells for intra-frequency prediction; cells for inter-frequency prediction; beams for prediction across cells and across frequencies; beams for prediction across cells in a serving frequency; beams for prediction per cell in the serving frequency; beams for prediction at a serving cell; beams per cell for intra-frequency prediction; beams per cell for inter-frequency prediction; or a combination thereof.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a UE, or a UE may include the apparatus 800. In some aspects, the apparatus 800 includes a reception component 802, a transmission component 804, or a communication manager 806, which may be in communication with one another (for example, via one or more buses or one or more other components). In some aspects, the communication manager 806 is the communication manager 150 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 140 described in connection with FIG. 1) of the UE.

In some aspects, the apparatus 800 may be configured to perform one or more operations described herein in connection with FIGS. 2-3. Additionally, or alternatively, the apparatus 800 may be configured to perform one or more processes described herein, such as process 400 of FIG. 4, process 600 of FIG. 6, or a combination thereof. In some aspects, the apparatus 800 or one or more components shown in FIG. 8 may include one or more components of the UE described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the UE described above in connection with FIG. 1, such as a radio, one or more RF chains, one or more transceivers, or one or more modems, each of which may in turn be coupled with one or more antennas of the UE.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 804 may be co-located with the reception component 802.

The communication manager 806 may support operations of the reception component 802 or the transmission component 804. For example, the communication manager 806 may receive information associated with configuring reception of communications by the reception component 802 or transmission of communications by the transmission component 804. Additionally, or alternatively, the communication manager 806 may generate or provide control information to the reception component 802 or the transmission component 804 to control reception or transmission of communications.

In some aspects, the transmission component 804 may transmit (e.g., to the apparatus 808) a capability message that includes at least a first parameter related to possible input for RRM prediction, measurement event prediction, or a combination thereof, and a second parameter related to possible output for RRM prediction, measurement event prediction, or a combination thereof. The reception component 802 may receive (e.g., from the apparatus 808) a report configuration based at least in part on the first parameter and the second parameter. The transmission component 804 may transmit (e.g., to the apparatus 808) a report according to the report configuration.

Additionally, or alternatively, the reception component 802 may receive (e.g., from the apparatus 808) a report configuration associated with RRM prediction or measurement event prediction, and the communication manager 806 may perform inference, using at least one measurement from a serving cell or a neighboring cell, to generate a cell prediction, a beam prediction, or an event prediction. Accordingly, the transmission component 804 may transmit (e.g., to the apparatus 808) a report indicating the cell prediction, the beam prediction, or the event prediction.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication. The apparatus 900 may be a network node, or a network node may include the apparatus 900. In some aspects, the apparatus 900 includes a reception component 902, a transmission component 904, or a communication manager 906, which may be in communication with one another (for example, via one or more buses or one or more other components). In some aspects, the communication manager 906 is the communication manager 155 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 145 described in connection with FIG. 1) of the network node.

In some aspects, the apparatus 900 may be configured to perform one or more operations described herein in connection with FIG. 3. Additionally, or alternatively, the apparatus 900 may be configured to perform one or more processes described herein, such as process 500 of FIG. 5, process 700 of FIG. 7, or a combination thereof. In some aspects, the apparatus 900 or one or more components shown in FIG. 9 may include one or more components of the network node described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the network node described above in connection with FIG. 1, such as a radio, one or more RF chains, one or more transceivers, or one or more modems, each of which may in turn be coupled with one or more antennas of the network node. In some aspects, the reception component 902 or the transmission component 904 may include or may be included in a network interface. The network interface may be configured to obtain or output signals for the apparatus 900 via one or more communications links, such as a backhaul link, a midhaul link, or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 904 may be co-located with the reception component 902.

The communication manager 906 may support operations of the reception component 902 or the transmission component 904. For example, the communication manager 906 may receive information associated with configuring reception of communications by the reception component 902 or transmission of communications by the transmission component 904. Additionally, or alternatively, the communication manager 906 may generate or provide control information to the reception component 902 or the transmission component 904 to control reception or transmission of communications.

In some aspects, the reception component 902 may receive (e.g., from the apparatus 908) a capability message that includes at least a first parameter related to possible input for RRM prediction, measurement event prediction, or a combination thereof, and a second parameter related to possible output for RRM prediction, measurement event prediction, or a combination thereof. The transmission component 904 may transmit (e.g., to the apparatus 908) a report configuration based at least in part on the first parameter and the second parameter. The reception component 902 may receive (e.g., from the apparatus 908) a report according to the report configuration.

Additionally, or alternatively, the transmission component 904 may transmit (e.g., to the apparatus 908) a report configuration associated with RRM prediction or measurement event prediction, and the reception component 902 may receive (e.g., from the apparatus 908) a report indicating a cell prediction, a beam prediction, or an event prediction based at least in part on inference using at least one measurement from a serving cell or a neighboring cell.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:
Aspect 1: A method of wireless communication performed by a user equipment (UE), comprising: transmitting a capability message that includes at least a first parameter related to possible input for radio resource management (RRM) prediction, measurement event prediction, or a combination thereof, and a second parameter related to possible output for RRM prediction, measurement event prediction, or a combination thereof; receiving a report configuration based at least in part on the first parameter and the second parameter; and transmitting a report according to the report configuration.
Aspect 2: The method of Aspect 1, wherein the first parameter indicates whether the UE supports synchronization signal blocks (SSBs), channel state information reference signals (CSI-RSs), or a combination thereof.
Aspect 3: The method of any of Aspects 1-2, wherein the second parameter indicates whether the UE supports a measurement set equal to a prediction set, a measurement set that is a subset of the prediction set, a measurement set that is different from the prediction set, or a combination thereof.
Aspect 4: The method of any of Aspects 1-3, wherein the first parameter indicates a maximum number of cells for measurement across frequencies, a maximum number of cells for intra-frequency measurement, a maximum number of cells for inter-frequency measurement, a maximum number of beams for measurement across cells and across frequencies, a maximum number of beams for measurement across cells in a serving frequency, a maximum number of beams for measurement per cell in a serving frequency, a maximum number of beams for measurement at a serving cell, a maximum number of beams per cell for intra-frequency measurement, a maximum number of beams per cell for inter-frequency measurement, or a combination thereof.
Aspect 5: The method of any of Aspects 1-4, wherein the second parameter indicates a maximum number of cells for prediction across frequencies, a maximum number of cells for intra-frequency prediction, a maximum number of cells for inter-frequency prediction, a maximum number of cells for inter-frequency prediction, a maximum number of beams for prediction across cells and across frequencies, a maximum number of beams for prediction across cells in a serving frequency, a maximum number of beams for prediction per cell in a serving frequency, a maximum number of beams for prediction at a serving cell, a maximum number of beams per cell for intra-frequency prediction, a maximum number of beams per cell for inter-frequency prediction, or a combination thereof.
Aspect 6: The method of any of Aspects 1-5, wherein the second parameter indicates whether the UE supports top beam prediction, top cell prediction, top beam prediction with predicted measurements, top cell prediction with predicted measurements, or a combination thereof.
Aspect 7: The method of any of Aspects 1-6, wherein the first and second parameters are associated with serving cell prediction and serving cell beam prediction for RRM.
Aspect 8: The method of Aspect 7, wherein the first parameter indicates a maximum number of beams of the serving cell to measure, a minimum number of beams of the serving cell to measure, a maximum number of neighboring cells to measure, whether the UE supports use of neighboring cells measurements, a minimum number of neighboring cells to measure, a maximum number of beams per neighboring cell to measure, whether the UE supports use of beam measurements from neighboring cells, a minimum number of beams per neighboring cell to measure, a maximum number of beams across the neighboring cells to measure, a minimum number of beams across the neighboring cells to measure, or a combination thereof.
Aspect 9: The method of any of Aspects 7-8, wherein the second parameter indicates a maximum number of beams of the serving cell to predict, a maximum number of measurements at the serving cell to predict, whether the UE supports cell quality prediction, which measurement events are supported by the UE, or a combination thereof.
Aspect 10: The method of any of Aspects 7-9, wherein the second parameter indicates a total number of beams of the serving cell, for prediction, across instances.
Aspect 11: The method of any of Aspects 7-10, wherein the first parameter indicates a minimum number of measurement instances for the serving cell, a minimum number of measurement instances for neighboring cells, a measurement periodicity for the serving cell, a measurement periodicity for neighboring cells, a prediction window for the serving cell, or a combination thereof.
Aspect 12: The method of any of Aspects 1-11, wherein the first and second parameters are associated with intra-frequency neighboring cell prediction and neighboring cell beam prediction for RRM.
Aspect 13: The method of Aspect 12, wherein the first parameter indicates a maximum number of beams of the neighboring cell to measure, a minimum number of beams of the neighboring cell to measure, a maximum number of other neighboring cells to measure, a minimum number of other neighboring cells to measure, a maximum number of beams per other neighboring cell to measure, a minimum number of beams per other neighboring cell to measure, a maximum number of beams across all neighboring cells to measure, or a combination thereof.
Aspect 14: The method of any of Aspects 12-13, wherein the second parameter indicates a maximum number of beams across neighboring cells to predict, a maximum number of beams per neighboring cell to predict, a maximum number of measurements across neighboring cells to predict, a maximum number of measurements per neighboring cell to predict, whether the UE supports cell quality prediction, which measurement events are supported by the UE, or a combination thereof.
Aspect 15: The method of any of Aspects 12-14, wherein the second parameter indicates a total number of beams of the neighboring cell, for prediction, across instances.
Aspect 16: The method of any of Aspects 12-15, wherein the first parameter indicates a minimum number of measurement instances for intra-frequency prediction, a measurement periodicity for intra-frequency prediction, a prediction window for the neighboring cell, or a combination thereof.
Aspect 17: The method of any of Aspects 1-16, wherein the first and second parameters are associated with inter-frequency neighboring cell prediction and neighboring cell beam prediction for RRM.
Aspect 18: The method of Aspect 17, wherein the first parameter indicates a list of frequencies to measure for inter-frequency prediction, a range of frequencies to measure for inter-frequency prediction, or a combination thereof.
Aspect 19: The method of any of Aspects 17-18, wherein the first parameter indicates a maximum number of beams of the neighboring cell to measure, a minimum number of beams of the neighboring cell to measure, a maximum number of other neighboring cells on a same frequency to measure, a minimum number of other neighboring cells on the same frequency to measure, a maximum number of beams per other neighboring cell on the same frequency to measure, a minimum number of beams per other neighboring cell on the same frequency to measure, a maximum number of beams per frequency to measure, a maximum number of other neighboring cells on different frequencies to measure, a minimum number of other neighboring cells on different frequencies to measure, a maximum number of beams per other neighboring cell on different frequencies to measure, a minimum number of beams per other neighboring cell on different frequencies to measure, a maximum number of beams across frequencies to measure, or a combination thereof.
Aspect 20: The method of any of Aspects 17-19, wherein the second parameter indicates a maximum number of beams across neighboring cells to predict, a maximum number of beams per neighboring cell to predict, a maximum number of measurements across neighboring cells to predict, a maximum number of measurements per neighboring cell to predict, whether the UE supports cell quality prediction, which measurement events are supported by the UE, or a combination thereof.
Aspect 21: The method of any of Aspects 17-20, wherein the second parameter indicates a total number of beams of the neighboring cell for prediction per frequency and across instances, a total number of beams of the neighboring cell for prediction across frequencies and across instances, a prediction window for the neighboring cell, or a combination thereof.
Aspect 22: The method of any of Aspects 17-21, wherein the first parameter indicates a minimum number of measurement instances on a same frequency, a minimum number of measurement instances across frequencies, a measurement periodicity for a same frequency, a measurement periodicity for other frequencies, or a combination thereof.
Aspect 23: The method of any of Aspects 1-22, wherein the second parameter indicates a maximum prediction window length or a minimum prediction window length for measurement event prediction.
Aspect 24: The method of any of Aspects 1-23, wherein the second parameter indicates a number of predicted instances and a time between the predicted instances supported by the UE, wherein the number comprises a maximum number or a minimum number or is included in a range of numbers supported by the UE, and wherein the time comprises a maximum time or a minimum time or is included in a range of times supported by the UE.
Aspect 25: The method of any of Aspects 1-24, wherein the second parameter indicates whether the UE supports probability reporting with measurement event prediction.
Aspect 26: The method of any of Aspects 1-25, wherein the first and second parameters are associated with direct prediction for measurement event prediction.
Aspect 27: The method of any of Aspects 1-26, wherein the first and second parameters are associated with indirect prediction for measurement event prediction.
Aspect 28: The method of any of Aspects 1-27, wherein the first parameter indicates a maximum number of beams of a serving cell to measure, a minimum number of beams of the serving cell to measure, a maximum number of beams of a target cell to measure, a minimum number of beams of the target cell to measure, a maximum number of beams of neighboring cells to measure, a minimum number of beams of the neighboring cells to measure, a maximum number of measurements to perform for the serving cell, a minimum number of measurements to perform for the serving cell, a maximum number of measurements to perform for the target cell, a minimum number of measurements to perform for the target cell, a maximum number of measurements to perform for the neighboring cells, a minimum number of measurements to perform for the neighboring cells, a maximum number of beams of a secondary cell (SCell) to measure, a minimum number of beams of the SCell to measure, a maximum number of measurements to perform for the SCell, a minimum number of measurements to perform for the SCell, or a combination thereof.
Aspect 29: A method of wireless communication performed by a network node, comprising: receiving a capability message, associated with a user equipment (UE), that includes at least a first parameter related to possible input for radio resource management (RRM) prediction, measurement event prediction, or a combination thereof, and a second parameter related to possible output for RRM prediction, measurement event prediction, or a combination thereof; transmitting a report configuration based at least in part on the first parameter and the second parameter; and receiving a report according to the report configuration.
Aspect 30: The method of Aspect 29, wherein the first parameter indicates whether the UE supports synchronization signal blocks (SSBs), channel state information reference signals (CSI-RSs), or a combination thereof.
Aspect 31: The method of any of Aspects 29-30, wherein the second parameter indicates whether the UE supports a measurement set equal to a prediction set, a measurement set that is a subset of the prediction set, a measurement set that is different from the prediction set, or a combination thereof.
Aspect 32: The method of any of Aspects 29-31, wherein the first parameter indicates a maximum number of cells for measurement across frequencies, a maximum number of cells for intra-frequency measurement, a maximum number of cells for inter-frequency measurement, a maximum number of beams for measurement across cells and across frequencies, a maximum number of beams for measurement across cells in a serving frequency, a maximum number of beams for measurement per cell in a serving frequency, a maximum number of beams for measurement at a serving cell, a maximum number of beams per cell for intra-frequency measurement, a maximum number of beams per cell for inter-frequency measurement, or a combination thereof.
Aspect 33: The method of any of Aspects 29-32, wherein the second parameter indicates a maximum number of cells for prediction across frequencies, a maximum number of cells for intra-frequency prediction, a maximum number of cells for inter-frequency prediction, a maximum number of cells for inter-frequency prediction, a maximum number of beams for prediction across cells and across frequencies, a maximum number of beams for prediction across cells in a serving frequency, a maximum number of beams for prediction per cell in a serving frequency, a maximum number of beams for prediction at a serving cell, a maximum number of beams per cell for intra-frequency prediction, a maximum number of beams per cell for inter-frequency prediction, or a combination thereof.
Aspect 34: The method of any of Aspects 29-33, wherein the second parameter indicates whether the UE supports top beam prediction, top cell prediction, top beam prediction with predicted measurements, top cell prediction with predicted measurements, or a combination thereof.
Aspect 35: The method of any of Aspects 29-34, wherein the first and second parameters are associated with serving cell prediction and serving cell beam prediction for RRM.
Aspect 36: The method of Aspect 35, wherein the first parameter indicates a maximum number of beams of the serving cell to measure, a minimum number of beams of the serving cell to measure, a maximum number of neighboring cells to measure, whether the UE supports use of neighboring cells measurements, a minimum number of neighboring cells to measure, a maximum number of beams per neighboring cell to measure, whether the UE supports use of beam measurements from neighboring cells, a minimum number of beams per neighboring cell to measure, a maximum number of beams across the neighboring cells to measure, a minimum number of beams across the neighboring cells to measure, or a combination thereof.
Aspect 37: The method of any of Aspects 35-36, wherein the second parameter indicates a maximum number of beams of the serving cell to predict, a maximum number of measurements at the serving cell to predict, whether the UE supports cell quality prediction, which measurement events are supported by the UE, or a combination thereof.
Aspect 38: The method of any of Aspects 35-37, wherein the second parameter indicates a total number of beams of the serving cell, for prediction, across instances.
Aspect 39: The method of any of Aspects 35-38, wherein the first parameter indicates a minimum number of measurement instances for the serving cell, a minimum number of measurement instances for neighboring cells, a measurement periodicity for the serving cell, a measurement periodicity for neighboring cells, a prediction window for the serving cell, or a combination thereof.
Aspect 40: The method of any of Aspects 29-39, wherein the first and second parameters are associated with intra-frequency neighboring cell prediction and neighboring cell beam prediction for RRM.
Aspect 41: The method of Aspect 40, wherein the first parameter indicates a maximum number of beams of the neighboring cell to measure, a minimum number of beams of the neighboring cell to measure, a maximum number of other neighboring cells to measure, a minimum number of other neighboring cells to measure, a maximum number of beams per other neighboring cell to measure, a minimum number of beams per other neighboring cell to measure, a maximum number of beams across all neighboring cells to measure, or a combination thereof.
Aspect 42: The method of any of Aspects 40-41, wherein the second parameter indicates a maximum number of beams across neighboring cells to predict, a maximum number of beams per neighboring cell to predict, a maximum number of measurements across neighboring cells to predict, a maximum number of measurements per neighboring cell to predict, whether the UE supports cell quality prediction, which measurement events are supported by the UE, or a combination thereof.
Aspect 43: The method of any of Aspects 40-42, wherein the second parameter indicates a total number of beams of the neighboring cell, for prediction, across instances.
Aspect 44: The method of any of Aspects 40-43, wherein the first parameter indicates a minimum number of measurement instances for intra-frequency prediction, a measurement periodicity for intra-frequency prediction, a prediction window for the neighboring cell, or a combination thereof.
Aspect 45: The method of any of Aspects 29-44, wherein the first and second parameters are associated with inter-frequency neighboring cell prediction and neighboring cell beam prediction for RRM.
Aspect 46: The method of Aspect 45, wherein the first parameter indicates a list of frequencies to measure for inter-frequency prediction, a range of frequencies to measure for inter-frequency prediction, or a combination thereof.
Aspect 47: The method of any of Aspects 45-46, wherein the first parameter indicates a maximum number of beams of the neighboring cell to measure, a minimum number of beams of the neighboring cell to measure, a maximum number of other neighboring cells on a same frequency to measure, a minimum number of other neighboring cells on the same frequency to measure, a maximum number of beams per other neighboring cell on the same frequency to measure, a minimum number of beams per other neighboring cell on the same frequency to measure, a maximum number of beams per frequency to measure, a maximum number of other neighboring cells on different frequencies to measure, a minimum number of other neighboring cells on different frequencies to measure, a maximum number of beams per other neighboring cell on different frequencies to measure, a minimum number of beams per other neighboring cell on different frequencies to measure, a maximum number of beams across frequencies to measure, or a combination thereof.
Aspect 48: The method of any of Aspects 45-47, wherein the second parameter indicates a maximum number of beams across neighboring cells to predict, a maximum number of beams per neighboring cell to predict, a maximum number of measurements across neighboring cells to predict, a maximum number of measurements per neighboring cell to predict, whether the UE supports cell quality prediction, which measurement events are supported by the UE, or a combination thereof.
Aspect 49: The method of any of Aspects 45-48, wherein the second parameter indicates a total number of beams of the neighboring cell for prediction per frequency and across instances, a total number of beams of the neighboring cell for prediction across frequencies and across instances, a prediction window for the neighboring cell, or a combination thereof.
Aspect 50: The method of any of Aspects 45-49, wherein the first parameter indicates a minimum number of measurement instances on a same frequency, a minimum number of measurement instances across frequencies, a measurement periodicity for a same frequency, a measurement periodicity for other frequencies, or a combination thereof.
Aspect 51: The method of any of Aspects 29-50, wherein the second parameter indicates a maximum prediction window length or a minimum prediction window length for measurement event prediction.
Aspect 52: The method of any of Aspects 29-51, wherein the second parameter indicates a number of predicted instances and a time between the predicted instances supported by the UE, wherein the number comprises a maximum number or a minimum number or is included in a range of numbers supported by the UE, and wherein the time comprises a maximum time or a minimum time or is included in a range of times supported by the UE.
Aspect 53: The method of any of Aspects 29-52, wherein the second parameter indicates whether the UE supports probability reporting with measurement event prediction.
Aspect 54: The method of any of Aspects 29-53, wherein the first and second parameters are associated with direct prediction for measurement event prediction.
Aspect 55: The method of any of Aspects 29-54, wherein the first and second parameters are associated with indirect prediction for measurement event prediction.
Aspect 56: The method of any of Aspects 29-55, wherein the first parameter indicates a maximum number of beams of a serving cell to measure, a minimum number of beams of the serving cell to measure, a maximum number of beams of a target cell to measure, a minimum number of beams of the target cell to measure, a maximum number of beams of neighboring cells to measure, a minimum number of beams of the neighboring cells to measure, a maximum number of measurements to perform for the serving cell, a minimum number of measurements to perform for the serving cell, a maximum number of measurements to perform for the target cell, a minimum number of measurements to perform for the target cell, a maximum number of measurements to perform for the neighboring cells, a minimum number of measurements to perform for the neighboring cells, a maximum number of beams of a secondary cell (SCell) to measure, a minimum number of beams of the SCell to measure, a maximum number of measurements to perform for the SCell, a minimum number of measurements to perform for the SCell, or a combination thereof.
Aspect 57: A method of wireless communication performed by a user equipment (UE), comprising: receiving a report configuration that includes at least a first parameter indicating measurement resources for radio resource management (RRM) prediction, measurement event prediction, or a combination thereof, and a second parameter indicating prediction resources for the RRM prediction, the measurement event prediction, or the combination thereof; and transmitting a prediction result for the prediction resources using the measurement resources and based on the report configuration.
Aspect 58: The method of Aspect 57, wherein the prediction result comprises a beam prediction for a serving cell using a measurement from the serving cell, a measurement from a neighboring cell, or a combination thereof.
Aspect 59: The method of Aspect 57, wherein the prediction result comprises a cell prediction or a beam prediction for a neighboring cell using a measurement from a serving cell, a measurement from the neighboring cell, a measurement from another cell in a same frequency, or a combination thereof.
Aspect 60: The method of Aspect 57, wherein the prediction result comprises a cell prediction or a beam prediction for a neighboring cell using a measurement from a serving cell, a measurement from the neighboring cell, a measurement from another cell in a same frequency, a measurement from another cell in a different frequency, or a combination thereof.
Aspect 61: The method of Aspect 57, wherein the prediction result comprises an event prediction for a serving cell.
Aspect 62: The method of Aspect 57, wherein the prediction result comprises an event prediction for a neighboring cell.
Aspect 63: The method of any of Aspects 57-62, wherein the first parameter indicates: a number of cells for measurement across frequencies; a number of cells for intra-frequency measurement; a number of cells for inter-frequency measurement; a number of beams for measurement across cells and across frequencies; a number of beams for measurement across cells in a serving frequency; a number of beams for measurement per cell in the serving frequency; a number of beams for measurement at a serving cell; a number of beams per cell for intra-frequency measurement; a number of beams per cell for inter-frequency measurement; or a combination thereof.
Aspect 64: The method of any of Aspects 57-63, wherein the first parameter indicates: cells for measurement across frequencies; cells for intra-frequency measurement; cells for inter-frequency measurement; beams for measurement across cells and across frequencies; beams for measurement across cells in a serving frequency; beams for measurement per cell in the serving frequency; beams for measurement at a serving cell; beams per cell for intra-frequency measurement; beams per cell for inter-frequency measurement; or a combination thereof.
Aspect 65: The method of any of Aspects 57-64, wherein the second parameter indicates: a number of cells for prediction across frequencies; a number of cells for intra-frequency prediction; a number of cells for inter-frequency prediction; a number of beams for prediction across cells and across frequencies; a number of beams for prediction across cells in a serving frequency; a number of beams for prediction per cell in the serving frequency; a number of beams for prediction at a serving cell; a number of beams per cell for intra-frequency prediction; a number of beams per cell for inter-frequency prediction; or a combination thereof.
Aspect 66: The method of any of Aspects 57-65, wherein the second parameter indicates: cells for prediction across frequencies; cells for intra-frequency prediction; cells for inter-frequency prediction; beams for prediction across cells and across frequencies; beams for prediction across cells in a serving frequency; beams for prediction per cell in the serving frequency; beams for prediction at a serving cell; beams per cell for intra-frequency prediction; beams per cell for inter-frequency prediction; or a combination thereof.
Aspect 67: A method of wireless communication performed by a network node, comprising: transmitting a report configuration associated with radio resource management (RRM) prediction or measurement event prediction; and receiving a report indicating a cell prediction, a beam prediction, or an event prediction based at least in part on inference using at least one measurement from a serving cell or a neighboring cell.
Aspect 68: The method of Aspect 67, wherein the prediction result comprises a beam prediction for a serving cell using a measurement from the serving cell, a measurement from a neighboring cell, or a combination thereof.
Aspect 69: The method of Aspect 67, wherein the prediction result comprises a cell prediction or a beam prediction for a neighboring cell using a measurement from a serving cell, a measurement from the neighboring cell, a measurement from another cell in a same frequency, or a combination thereof.
Aspect 70: The method of Aspect 67, wherein the prediction result comprises a cell prediction or a beam prediction for a neighboring cell using a measurement from a serving cell, a measurement from the neighboring cell, a measurement from another cell in a same frequency, a measurement from another cell in a different frequency, or a combination thereof.
Aspect 71: The method of Aspect 67, wherein the prediction result comprises an event prediction for a serving cell.
Aspect 72: The method of Aspect 67, wherein the prediction result comprises an event prediction for a neighboring cell.
Aspect 73: The method of any of Aspects 67-72, wherein the first parameter indicates: a number of cells for measurement across frequencies; a number of cells for intra-frequency measurement; a number of cells for inter-frequency measurement; a number of beams for measurement across cells and across frequencies; a number of beams for measurement across cells in a serving frequency; a number of beams for measurement per cell in the serving frequency; a number of beams for measurement at a serving cell; a number of beams per cell for intra-frequency measurement; a number of beams per cell for inter-frequency measurement; or a combination thereof.
Aspect 74: The method of any of Aspects 67-73, wherein the first parameter indicates: cells for measurement across frequencies; cells for intra-frequency measurement; cells for inter-frequency measurement; beams for measurement across cells and across frequencies; beams for measurement across cells in a serving frequency; beams for measurement per cell in the serving frequency; beams for measurement at a serving cell; beams per cell for intra-frequency measurement; beams per cell for inter-frequency measurement; or a combination thereof.
Aspect 75: The method of any of Aspects 67-74, wherein the second parameter indicates: a number of cells for prediction across frequencies; a number of cells for intra-frequency prediction; a number of cells for inter-frequency prediction; a number of beams for prediction across cells and across frequencies; a number of beams for prediction across cells in a serving frequency; a number of beams for prediction per cell in the serving frequency; a number of beams for prediction at a serving cell; a number of beams per cell for intra-frequency prediction; a number of beams per cell for inter-frequency prediction; or a combination thereof.
Aspect 76: The method of any of Aspects 67-75, wherein the second parameter indicates: cells for prediction across frequencies; cells for intra-frequency prediction; cells for inter-frequency prediction; beams for prediction across cells and across frequencies; beams for prediction across cells in a serving frequency; beams for prediction per cell in the serving frequency; beams for prediction at a serving cell; beams per cell for intra-frequency prediction; beams per cell for inter-frequency prediction; or a combination thereof.
Aspect 77: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-76.
Aspect 78: An apparatus for wireless communication at a device, the apparatus comprising one or more memories and one or more processors coupled to the one or more memories, the one or more processors configured to cause the device to perform the method of one or more of Aspects 1-76.
Aspect 79: An apparatus for wireless communication, the apparatus comprising at least one means for performing the method of one or more of Aspects 1-76.
Aspect 80: A non-transitory computer-readable medium storing code for wireless communication, the code comprising instructions executable by one or more processors to perform the method of one or more of Aspects 1-76.
Aspect 81: A non-transitory computer-readable medium storing a set of instructions for wireless communication, the set of instructions comprising one or more instructions that, when executed by one or more processors of a device, cause the device to perform the method of one or more of Aspects 1-76.
Aspect 82: A device for wireless communication, the device comprising a processing system that includes one or more processors and one or more memories coupled with the one or more processors, the processing system configured to cause the device to perform the method of one or more of Aspects 1-76.
Aspect 83: An apparatus for wireless communication at a device, the apparatus comprising one or more memories and one or more processors coupled to the one or more memories, the one or more processors individually or collectively configured to cause the device to perform the method of one or more of Aspects 1-76.
Aspect 84: A device comprising a processing system that includes one or more processors and one or more code-storing memories coupled with the one or more processors, the processing system configured to cause the device to perform the method of one or more of Aspects 1-76.
Aspect 85: A device comprising a processing system that includes processor circuitry and code-storing memory circuitry, the processing system configured to cause the device to perform the method of one or more of Aspects 1-76.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

The terms “transmit path” or “transmission path” may refer to a circuit path within a transmitting device along which a signal to be transmitted is constructed and transformed via channel encoding circuitry, modem (modulation) circuitry, RF and analog circuitry, or other circuitry, such that it may be applied to one or more antennas for wireless transmission by a transmitting device (such as a UE 120 or a network node 110) to a receiving device (such as the other of the UE 120 or the network node 110). As used herein, the terms “transmit,” “transmission,” “transmitting,” “transmitted,” or other derivatives thereof, refer to the action of physically emanating, radiating or emitting (herein used interchangeably), by one or more antennas, electromagnetic radiation representing a desired signal (for example, in the form of an OFDM, OFDMA, CP-OFDM, DFT-S-OFDM, filtered OFDM (F-OFDM), on-off keying (OOK), ultra-wideband (UWB), universal filtered muti-carrier (UFMC) or other waveform) wirelessly out into the surrounding environment (also referred to as the “wireless medium”) in the form of radio waves at radio frequencies (RFs) (for example, frequencies in the range of 100 kHz to 300 GHz) for reception by a receiving device. This is often referred to as transmitting “over-the-air (OTA),” meaning that the signal, as it propagates, is not confined or guided by a wired or other conductive medium, a fiber optic cable, or other structural channel. When a transmitting device, such as a UE 120 or a network node 110, performs a transmission of an electromagnetic signal OTA, the RF and analog circuitry or other circuitry, such as in an antenna module of the transmitting device, applies the signal to one or more antennas from which the signal is physically transmitted; that is, emitted from an antenna as a radio wave. The terms “receive path” or “reception path” may refer to a circuit path along which a signal is received from one or more antennas and transformed via RF and analog circuitry, modem (demodulation) circuitry, channel decoding circuitry or other circuitry for provision to processor circuitry. As used herein, the terms “receive,” “reception,” “receiving,” “received,” or other derivatives thereof, refer to the action of one or more antennas receiving, such as being electrically excited or stimulated by, electromagnetic radiation in the form of radio waves from the surrounding wireless medium. This is often referred to as receiving OTA.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet, such as data or control signaling. In some other such examples, determining can involve a processor selecting or choosing one or more values, sets, elements or other information or results from a larger set of values, sets, elements, or other information or results. In some other such examples, determining can involve a processor performing a measurement, such as on a received signal.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, the term “A or B” as well as the term “A and/or B” may include A only, B only, or a combination of both A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “based on” is equivalent to “based at least in part on” and indicates a non-limiting relationship between elements “a” and “b.” In some aspects, a′ (which may be a variation or example of a) may be responsive to or in response to b′ (which may be a variation or example of b), such as if condition c is met. In some other aspects, a″ (which may be a variation or example of at least one of a or a′) may be associated with b″ (which may be a variation or example of at least one of b or b′). In some further aspects, a″′ (which may be a variation or example of at least one of a or a′ or a″) may be determined (or any of the other actions encompassed by usage of the word “determining” as described above) in accordance with b″′ (which may be a variation or example of at least one of b or b′ or b″). Furthermore, what follows the phrase “in accordance with,” “as a function of,” “in response to,” “responsive to,” or “using” is not necessarily the focal point or primary factor associated with the limitation preceding the phrase. For example, the phrases “in accordance with,” “based on,” “based at least in part on,” “as a function of,” “in response to,” “responsive to,” “associated with,” or “using” are not to be construed as a reference to a closed set of conditions, factors, criteria, elements, components or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the scope of this disclosure. Thus, the claims are not intended to be limited to the examples shown herein but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. Moreover, the separation of various system components in the examples described above should not be understood as requiring such separation in all examples, and it should be understood that the described program components and systems can generally be integrated together in a single software product or packaged into multiple software products.

What is claimed is:

1. A user equipment (UE), comprising:
an antenna system that includes one or more antennas; and
a processing system that includes one or more processors and one or more memories that store code and are coupled with the one or more processors, the processing system configured to cause the UE:
wirelessly transmit, via the antenna system, a capability message that includes at least a first parameter related to possible input for radio resource management (RRM) prediction, measurement event prediction, or a combination thereof, and a second parameter related to possible output for RRM prediction, measurement event prediction, or a combination thereof;
wirelessly receive, via the antenna system, a report configuration based at least in part on the first parameter and the second parameter; and
wirelessly transmit, via the antenna system, a report according to the report configuration.

2. The UE of claim 1, wherein the first parameter indicates whether the UE supports synchronization signal blocks (SSBs), channel state information reference signals (CSI-RSs), or a combination thereof.

3. The UE of claim 1, wherein the second parameter indicates whether the UE supports a measurement set equal to a prediction set, a measurement set that is a subset of the prediction set, a measurement set that is different from the prediction set, or a combination thereof.

4. The UE of claim 1, wherein the first parameter indicates a maximum number of cells for measurement across frequencies, a maximum number of cells for intra-frequency measurement, a maximum number of cells for inter-frequency measurement, a maximum number of beams for measurement across cells and across frequencies, a maximum number of beams for measurement across cells in a serving frequency, a maximum number of beams for measurement per cell in a serving frequency, a maximum number of beams for measurement at a serving cell, a maximum number of beams per cell for intra-frequency measurement, a maximum number of beams per cell for inter-frequency measurement, or a combination thereof.

5. The UE of claim 1, wherein the second parameter indicates a maximum number of cells for prediction across frequencies, a maximum number of cells for intra-frequency prediction, a maximum number of cells for inter-frequency prediction, a maximum number of cells for inter-frequency prediction, a maximum number of beams for prediction across cells and across frequencies, a maximum number of beams for prediction across cells in a serving frequency, a maximum number of beams for prediction per cell in a serving frequency, a maximum number of beams for prediction at a serving cell, a maximum number of beams per cell for intra-frequency prediction, a maximum number of beams per cell for inter-frequency prediction, or a combination thereof.

6. The UE of claim 1, wherein the second parameter indicates whether the UE supports top beam prediction, top cell prediction, top beam prediction with predicted measurements, top cell prediction with predicted measurements, or a combination thereof.

7. The UE of claim 1, wherein the first and second parameters are associated with serving cell prediction and serving cell beam prediction for RRM.

8. The UE of claim 1, wherein the first and second parameters are associated with intra-frequency neighboring cell prediction and neighboring cell beam prediction for RRM.

9. The UE of claim 1, wherein the first and second parameters are associated with inter-frequency neighboring cell prediction and neighboring cell beam prediction for RRM.

10. The UE of claim 1, wherein the second parameter indicates a maximum prediction window length or a minimum prediction window length for measurement event prediction.

11. The UE of claim 1, wherein the second parameter indicates a number of predicted instances and a time between the predicted instances supported by the UE, wherein the number comprises a maximum number or a minimum number or is included in a range of numbers supported by the UE, and wherein the time comprises a maximum time or a minimum time or is included in a range of times supported by the UE.

12. The UE of claim 1, wherein the second parameter indicates whether the UE supports probability reporting with measurement event prediction.

13. The UE of claim 1, wherein the first and second parameters are associated with direct prediction or indirect prediction for measurement event prediction.

14. The UE of claim 1, wherein the first parameter indicates a maximum number of beams of a serving cell to measure, a minimum number of beams of the serving cell to measure, a maximum number of beams of a target cell to measure, a minimum number of beams of the target cell to measure, a maximum number of beams of neighboring cells to measure, a minimum number of beams of the neighboring cells to measure, a maximum number of measurements to perform for the serving cell, a minimum number of measurements to perform for the serving cell, a maximum number of measurements to perform for the target cell, a minimum number of measurements to perform for the target cell, a maximum number of measurements to perform for the neighboring cells, a minimum number of measurements to perform for the neighboring cells, a maximum number of beams of a secondary cell (SCell) to measure, a minimum number of beams of the SCell to measure, a maximum number of measurements to perform for the SCell, a minimum number of measurements to perform for the SCell, or a combination thereof.

15. A user equipment (UE), comprising:
an antenna system that includes one or more antennas; and
a processing system that includes one or more processors and one or more memories that store code and are coupled with the one or more processors, the processing system configured to cause the UE:
wirelessly transmit, via the antenna system, a report configuration that includes at least a first parameter indicating measurement resources for radio resource management (RRM) prediction, measurement event prediction, or a combination thereof, and a second parameter indicating prediction resources for the RRM prediction, the measurement event prediction, or the combination thereof; and
wirelessly transmit, via the antenna system, a prediction result for the prediction resources using the measurement resources and based on the report configuration.

16. The UE of claim 15, wherein the first parameter indicates:
a number of cells for measurement across frequencies;
a number of cells for intra-frequency measurement;
a number of cells for inter-frequency measurement;
a number of beams for measurement across cells and across frequencies;
a number of beams for measurement across cells in a serving frequency;
a number of beams for measurement per cell in the serving frequency;
a number of beams for measurement at a serving cell;
a number of beams per cell for intra-frequency measurement;
a number of beams per cell for inter-frequency measurement; or
a combination thereof.

17. The UE of claim 15, wherein the first parameter indicates:
cells for measurement across frequencies;
cells for intra-frequency measurement;
cells for inter-frequency measurement;
beams for measurement across cells and across frequencies;
beams for measurement across cells in a serving frequency;
beams for measurement per cell in the serving frequency;
beams for measurement at a serving cell;
beams per cell for intra-frequency measurement;
beams per cell for inter-frequency measurement; or
a combination thereof.

18. The UE of claim 15, wherein the second parameter indicates:
a number of cells for prediction across frequencies;
a number of cells for intra-frequency prediction;
a number of cells for inter-frequency prediction;
a number of beams for prediction across cells and across frequencies;
a number of beams for prediction across cells in a serving frequency;
a number of beams for prediction per cell in the serving frequency;
a number of beams for prediction at a serving cell;
a number of beams per cell for intra-frequency prediction;
a number of beams per cell for inter-frequency prediction; or
a combination thereof.

19. The UE of claim 15, wherein the second parameter indicates:
cells for prediction across frequencies;
cells for intra-frequency prediction;
cells for inter-frequency prediction;
beams for prediction across cells and across frequencies;
beams for prediction across cells in a serving frequency;
beams for prediction per cell in the serving frequency;
beams for prediction at a serving cell;
beams per cell for intra-frequency prediction;
beams per cell for inter-frequency prediction; or
a combination thereof.

20. A method of wireless communication performed by a user equipment (UE), comprising:
transmitting a capability message that includes at least a first parameter related to possible input for radio resource management (RRM) prediction, measurement event prediction, or a combination thereof, and a second parameter related to possible output for RRM prediction, measurement event prediction, or a combination thereof;
receiving a report configuration based at least in part on the first parameter and the second parameter; and
transmitting a report according to the report configuration.
